(19) United States
(12) Patent Application Publication
(10) Pub. No.: US 2024/0281495 A1
(43) Pub. Date: Aug. 22, 2024

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Kazuki TANABE, Tokyo (JP); Takayuki Kuroda, Tokyo (JP)

(73) Assignee: NEC Corporation, Tokyo (JP)

(21) Appl. No.: 18/432,186

(22) Filed: Feb. 5, 2024

(30) Foreign Application Priority Data
Feb. 16, 2023 (JP) 2023-022873

(51) Int. Cl. G06F 17/12

(52) U.S. Cl. CPC G06F 17/12

(57) ABSTRACT

An information processing apparatus to perform: acquiring configuration proposal information including a plurality of first quantitative requirements; calculating an expected value of each of the quantitative values in each of the first quantitative requirements based on a second quantitative requirement that is a combination of quantitative requirements each representing a requirement in which a quantitative value regarding configurations of a plurality of second information communication systems is set; converting, for each of the first quantitative requirements, a value range of the expected value of each of the quantitative values of the first quantitative requirement to a certain range based on a normalization function defined according to a type of the first quantitative requirement; calculating an evaluation value of the configuration proposal information based on the converted expected values of the quantitative values of the first quantitative requirements; and outputting the evaluation value to an output device.

### CROSS-REFERENCE TO RELATED APPLICATION

This application is based upon and claims the benefit of priority from Japanese patent application No. 2023-022873, filed on Feb. 16, 2023, the disclosure of which is incorporated herein in its entirety by reference.

### BACKGROUND OF THE INVENTION

### 1. Field of the Invention

The present disclosure relates to an information processing apparatus, an information processing method, and a computer-readable recording medium.

### 2. Background Art

The steps required to construct an information communication technology (ICT) system include a design step of designing a concrete system configuration that satisfies the requirements for the system. In the design step, the suitability of a proposal for a concrete configuration (configuration proposal) created based on requirements needs to be judged from a variety of perspectives including not only functional requirements but also performance requirements such as bandwidth.

Patent Document 1 (JP 6989014B) describes an ICT system automatic design technology that uses machine learning (i.e., a learning-based system automatic design technology), which aims to reduce the man-hour burden associated with designing an ICT system. In this technology, an artificial intelligence (AI) that has learned knowledge pertaining to system design by engineers (design knowledge) repeatedly applies a means (reification means) for partially reifying abstract elements included in abstract system configuration information (requirements). This makes it possible to quickly generate highly reliable specific system configuration information.

Non-Patent Document 1 (Takayuki Kuroda, Yutaka Yakuwa, Kazuki Tanabe, Journal of the Institute of Information and Communication Engineers, Vol. 105, No. 10, pp. 1208 to 1214 October 2022) describes an ICT system automatic design technology that uses machine learning, which is a further extension of the learning-based system automatic design technology described in Patent Document 1. This technology enables AI to not only learn the system functional requirements that could be learned using the technology in Patent Document 1, but also learn quantitative requirements such as system bandwidth performance, delay performance, and cost. This therefore enables AI to pseudo-acquire more advanced design knowledge pertaining to system design by engineers, and makes it possible for system configurations that satisfy a wider variety of requirements to be designed more quickly and with even higher reliability. In the automatic design technology described in Non-Patent Document 1, the suitability of a designed configuration proposal is evaluated by calculating an evaluation value for the configuration proposal based on expected values of quantitative values regarding quantitative requirements such as delay, bandwidth, and cost, which are calculated by an AI. However, in Non-Patent Document 1, it is necessary to manually adjust the units in which the quantitative values are expressed, the direction of quantitative value optimization (maximization or minimization), and weights expressing priority among the quantitative requirements, and therefore the evaluation of configuration proposals cannot be fully automated.

Patent Document 2 (JP 2021-152854A) describes an information processing apparatus that can select important explanatory variables with high accuracy when a computer processes data having many explanatory variables. In this technology, when multiple explanatory variables are to be used to calculate a predetermined objective variable, weighting coefficients indicating degrees of importance of the explanatory variables are calculated by multiple methods such as multiple regression, support vector regression, and decision trees, and explanatory variables having a high importance are extracted and output based on the results. This makes it possible for important explanatory variables to be selected with high accuracy, and makes it possible to further improve accuracy in the calculation of an objective variable.

Patent Document 3 (JP 2021-117662A) describes a feature evaluation apparatus for use in a support vector machine, which is one example of a pattern recognition model used in supervised machine learning, and this feature evaluation apparatus is for simultaneously evaluating the degree of influence that each of multiple features making up input data has on an identification result of the model and evaluating the degree of difficulty of the identification. In this technology, weighting coefficients are calculated for multiple features extracted from data to be classified, by normalizing the values of the features and then calculating an identification boundary with use of the normalized features, and then the values of the weighting coefficients are normalized. Accordingly, when data has multidimensional features of different sizes, it is possible to evaluate the degree of difficulty of feature identification while simultaneously maintaining the relative degrees of influence that the features have on the identification result.

As mentioned above, in the automatic design technology described in Non-Patent Document 1, when evaluating a configuration proposal designed with respect to multiple quantitative requirements, it is necessary to manually adjust the units of the quantitative values handled by the quantitative requirements, the direction of quantitative value optimization, and the weights of the quantitative requirements. Therefore, it has not been possible to completely automate the evaluation of configuration proposals.

Even with a conventional machine learning-related technology that aims to handle multiple numerical values in a complex manner, when taking all of the above-mentioned factors into consideration, it has not been possible for an evaluation value that is a single scalar value to be automatically calculated based on multiple numerical values.

For example, with the technology described in Patent Document 2, variables that have high importance with regard to the value of an objective variable can be selected from among multiple defined explanatory variables, but there is no examination of a specific means for calculating the objective variable based on the selected explanatory variables.

Furthermore, with the technology disclosed in Patent Document 3, when data has multidimensional features, classification of the data based on the features is made easier by normalizing the variables of the features and the weights of the features. However, with the technology described in Patent Document 3, there is no examination of a specific means for unifying the direction of optimization in the case where there is a mixture of features with different directions of optimization, such as when there are both features that are to be maximized due to being more preferable when having a larger numerical value, and features that are to be minimized due to being more preferable when having a smaller numerical value. Also, in the technology disclosed in Patent Document 3, there is no examination of a means for calculating a scalar value representing the suitability of data with consideration given to all features.

Therefore, in order to achieve complete automation of design that gives consideration to multiple quantitative requirements, there is desire for a mechanism by which an evaluation value that is a scalar value indicating the suitability of a configuration proposal can be automatically generated with consideration given to such quantitative requirements having different value systems.

### SUMMARY OF THE INVENTION

One example of an object of the present disclosure is to achieve an improvement in quality and speed in ICT system design.

In order to achieve the example object described above, an information processing apparatus according to an example aspect includes:
a first acquisition unit that acquires configuration proposal information including a plurality of first quantitative requirements that are each a combination of quantitative requirements each representing a requirement in which a quantitative value regarding a configuration of a first information communication system is set;
an expected value calculation unit that calculates an expected value of each of the quantitative values in each of the first quantitative requirements based on a second quantitative requirement that is a combination of quantitative requirements each representing a requirement in which a quantitative value regarding configurations of a plurality of second information communication systems is set;
a normalization unit that, for each of the first quantitative requirements, converts a value range of the expected value of each of the quantitative values of the first quantitative requirement to a certain range based on a normalization function defined according to a type of the first quantitative requirement;
an evaluation value calculation unit that calculates an evaluation value of the configuration proposal information based on the converted expected values of the quantitative values of the first quantitative requirements; and an output control unit that outputs the evaluation value to an output device.

Also, in order to achieve the example object described above, an information processing method according to an example aspect for a computer to carry out:
acquiring configuration proposal information including a plurality of first quantitative requirements that are each a combination of quantitative requirements each representing a requirement in which a quantitative value regarding a configuration of a first information communication system is set;
calculating an expected value of each of the quantitative values in each of the first quantitative requirements based on a second quantitative requirement that is a combination of quantitative requirements each representing a requirement in which a quantitative value regarding configurations of a plurality of second information communication systems is set;
converting, for each of the first quantitative requirements, a value range of the expected value of each of the quantitative values of the first quantitative requirement to a certain range based on a normalization function defined according to a type of the first quantitative requirement; calculating an evaluation value of the configuration proposal information based on the converted expected values of the quantitative values of the first quantitative requirements; and outputting the evaluation value to an output device.

Furthermore, in order to achieve the example object described above, a computer-readable recording medium according to an example aspect includes a program recorded on the computer-readable recording medium, the program including instructions that cause the computer to carry out:
acquiring configuration proposal information including a plurality of first quantitative requirements that are each a combination of quantitative requirements each representing a requirement in which a quantitative value regarding a configuration of a first information communication system is set;
calculating an expected value of each of the quantitative values in each of the first quantitative requirements based on a second quantitative requirement that is a combination of quantitative requirements each representing a requirement in which a quantitative value regarding configurations of a plurality of second information communication systems is set;
converting, for each of the first quantitative requirements, a value range of the expected value of each of the quantitative values of the first quantitative requirement to a certain range based on a normalization function defined according to a type of the first quantitative requirement;
calculating an evaluation value of the configuration proposal information based on the converted expected values of the quantitative values of the first quantitative requirements; and
outputting the evaluation value to an output device.

As described above, according to the present disclosure, it is possible to achieve an improvement in quality and speed in ICT system design.

### BRIEF DESCRIPTION OF THE DRAWINGS

FIG. 1 is a diagram for describing an example of an information processing apparatus 1 according to a first example embodiment.

FIG. 2 is a block diagram showing an example of the configuration of the information processing apparatus according to the first example embodiment.

FIG. 3 is a diagram illustrating an example of content of the configuration proposal according to the first example embodiment.

FIG. 4 is a diagram in which the content of the configuration proposal shown in FIG. 3 is visually expressed using a graph structure.

FIG. 5 is a diagram illustrating an example of quantitative requirement classification processing performed by the quantitative requirement classification unit according to the first example embodiment.

FIG. 6 is a diagram illustrating an example of quantitative unit conversion processing for converting the unit of a quantitative value of a quantitative requirement, which is performed by the unit adjustment unit according to the first example embodiment.

FIG. 7 is a diagram illustrating an example of processing for adjusting the direction of optimization of quantitative requirements performed by the direction adjustment unit according to the first example embodiment.

FIG. 8 is a block diagram illustrating an example of processing for calculating expected values of quantitative values, which is performed by the expected value calculation unit according to the first example embodiment.

FIG. 9 is a graph showing an example of a normalization function fmax(x) according to the first example embodiment.

FIG. 10 is a graph showing an example of a sigmoid function S(x) according to the first example embodiment.

FIG. 11 is a graph showing an example of a normalization function fmin(x) according to the first example embodiment.

FIG. 12 is a graph showing an example of a normalization function f(x) according to the first example embodiment.

FIG. 13 is a block diagram illustrating an example of quantitative value normalization processing performed by the quantitative value normalization unit according to the first example embodiment.

FIG. 14 is a diagram illustrating an example of evaluation value calculation processing performed by the evaluation value calculation unit according to the first example embodiment.

FIG. 15 is a diagram illustrating an example of the unit conversion information according to the first example embodiment.

FIG. 16 is a diagram illustrating an example of the normalization function definition information according to the first example embodiment.

FIG. 17 is a flowchart showing operation of the information processing apparatus according to the first example embodiment.

FIG. 18 is a block diagram showing an example of the configuration of an information processing apparatus according to a second example embodiment.

FIG. 19 is a diagram illustrating an example of descriptions in the requirement according to the second example embodiment.

FIG. 20 is a diagram in which the content of the requirement 600 shown in FIG. 19 is visually expressed using a graph structure.

FIG. 21 is a diagram illustrating an example of configuration reification processing according to the second example embodiment.

FIG. 22 is a diagram illustrating an example of the reification rule information according to the second example embodiment.

FIG. 23 is a diagram illustrating an example of design processing performed by the system configuration design apparatus according to the second example embodiment.

FIG. 24 is a block diagram showing an example of the configuration of the information processing apparatus according to the second example embodiment.

FIG. 25 is a diagram illustrating an example of the weight-evaluation value correlation data according to the second example embodiment.

FIG. 26 is a diagram illustrating an example of processing for normalizing the weights of the quantitative requirements performed by the coefficient adjustment unit according to the second example embodiment.

FIG. 27 is a flowchart showing operation of the system configuration design apparatus according to the second example embodiment.

FIG. 28 is a flowchart showing details of the evaluation value calculation processing (step S205 in FIG. 27) performed by the information processing apparatus according to the second example embodiment.

FIG. 29 is a diagram illustrating an example of a computer that realizes the information processing apparatus in the first and second example embodiments.

### EXEMPLARY EMBODIMENT

Hereinafter, example embodiments will be described with reference to the drawings. Note that in the drawings described below, elements having the same or corresponding functions are denoted by the same reference signs, and repeated description thereof may be omitted.

### EXAMPLE EMBODIMENTS

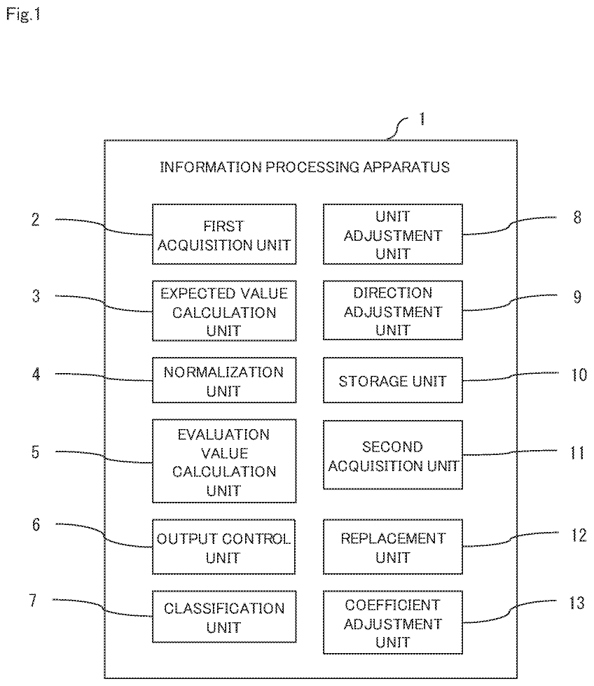

The following describes the configuration of an information processing apparatus according to example embodiments with reference to FIG. 1. FIG. 1 is a diagram for describing an example of an information processing apparatus 1 according to an example embodiment.

### [Apparatus Configuration]

The information processing apparatus 1 shown in FIG. 1 includes a first acquisition unit 2, an expected value calculation unit 3, a normalization unit 4, and an evaluation value calculation unit 5. Examples of the information processing apparatus 1 include an information processing apparatus 100, a system configuration design system 103, and an information processing apparatus 101, which will be described later.

The first acquisition unit 2 acquires configuration proposal information. One example of the configuration proposal information is a configuration proposal 200, which will be described later. The configuration proposal information includes a plurality of first quantitative requirements that are each a combination of quantitative requirements. A quantitative requirement represents a requirement in which a quantitative value regarding the configuration of a first information communication system is set. A quantitative requirement is a quantitative configuration requirement defined when designing the configuration of an ICT system, such as bandwidth performance, delay performance, and cost of the ICT system or components thereof. Each of the first quantitative requirements is one quantitative requirement set, which is a combination of quantitative requirements. More specifically, each of the first quantitative requirements is one set of quantitative requirements regarding a first information communication system and elements that constitute the first information communication system (including relationships between such elements). One example of the first quantitative requirement is a quantitative requirement 201 (201a, 201b, 201c, 201d, 201e), which will be described later. One example of the first acquisition unit 2 is a quantitative requirement classification unit 110, which will be described later.

The expected value calculation unit 3 calculates an expected value of the quantitative value of each of the first quantitative requirements, based on a second quantitative requirement. Here, the expected value is an average of random variables used in probability statistics. The second quantitative requirement is a combination of quantitative requirements. Here, the quantitative requirements each represent a requirement in which a quantitative value regarding the configurations of a plurality of second information communication systems is set. Therefore, the second quantitative requirement represents one quantitative requirement set, which is a combination of quantitative requirements. An example of the expected value calculation unit 3 is an expected value calculation unit 140, which will be described later. Specifically, the expected value calculation unit 3 uses a first artificial intelligence, which has been trained based on the second quantitative requirement, to calculate an expected value of the quantitative value of each of the first quantitative requirements. One example of the first artificial intelligence is a quantitative requirement AI 500, which will be described later.

For each of first quantitative requirements, the normalization unit 4 converts the value range of the expected value of the quantitative value of the first quantitative requirement into a certain range based on a normalization function defined according to the type of the first quantitative requirement. One example of the normalization unit 4 is a quantitative value normalization unit 150, which will be described later.

The evaluation value calculation unit 5 calculates an evaluation value of configuration proposal information based on the converted expected values of the quantitative values of the first quantitative requirements. One example of the evaluation value calculation unit 5 is an evaluation value calculation unit 160, which will be described later.

An output control unit 6 outputs the evaluation values to an output device. One example of the output control unit 6 is the evaluation value calculation unit 160, which will be described later. Examples of the output device include a storage device (including a built-in storage device or an external storage device), a display device, a printer, a communication interface, another computer, and a data writer capable of writing to a storage medium.

With this configuration, it is possible to achieve an improvement in quality and speed in ICT system design. More specifically, it is possible to achieve an improvement in quality and speed in ICT system design that uses automatic learning-based system design technology. In other words, an evaluation value can be obtained with high quality and at high speed for a designed configuration proposal, and as a result, a configuration proposal having a high evaluation value (a high-quality configuration proposal) can be obtained as a design result.

The information processing apparatus further includes a classification unit 7. The classification unit 7 classifies the first quantitative requirements based on the types of the first quantitative requirements. One example of the classification unit 7 is a quantitative requirement classification unit 110, which will be described later.

According to this configuration, each of the first quantitative requirements can be classified according to the type of the quantitative requirement (e.g., bandwidth, delay, and cost) of the first quantitative requirement.

The information processing apparatus 1 further includes a unit adjustment unit 8. The unit adjustment unit 8 performs unit conversion on the quantitative value included in each of the first quantitative requirements based on the type of the first quantitative requirement. One example of the unit adjustment unit 8 is a unit adjustment unit 120, which will be described later. According to this configuration, the scale of a unit can be adjusted.

The information processing apparatus 1 further includes a direction adjustment unit 9. The direction adjustment unit 9 determines a direction of optimization for the quantitative value of each of the first quantitative requirements based on predetermined information included in the first quantitative requirement. The predetermined information is information set in a “direction” field that defines a quantitative value optimization direction defined for each quantitative requirement, as described later, for example.

According to this configuration, the direction of optimization of the quantitative values of the first quantitative requirements can be adjusted.

The information processing apparatus 1 further includes a storage unit 10. The storage unit 10 stores first conversion information and normalization function definition information. The first conversion information is information that defines a unit conversion rule for conversion between units of quantitative values in a first quantitative requirement. One example of the first conversion information is unit conversion information 171, which will be described later. The normalization function definition information is information regarding a normalization function defined according to the type of a corresponding first quantitative requirement. One example of the normalization function definition information is normalization function definition information 172, which will be described later. One example of the storage unit 10 is a storage unit 170, which will be described later.

According to this configuration, the unit adjustment unit 8 can perform quantitative value unit conversion, and the normalization unit 4 can convert the value range of the expected value of the quantitative value of each of the first quantitative requirements into a certain range.

The normalization unit 4 converts the value range of the quantitative value defined in each of the first quantitative requirements to a certain range based on an upper limit value of the quantitative value or a lower limit value of the quantitative value, or based on a normalization function determined using the definitions of the upper limit value and the lower limit value of the quantitative value.

According to this configuration, the magnitude of a quantitative value can be normalized to a certain range.

The information processing apparatus 1 further includes a second acquisition unit 11 and a replacement unit 12. The second acquisition unit 11 acquires requirement information that includes a plurality of first requirements. Each of the first requirements is information that includes a combination of requirements regarding a configuration of a first information communication system. Each of the first requirements is requirement information including a requirement that abstractly represents a component, a constraint, or the like required of the target ICT system. One example of the first requirement is a requirement 600, which will be described later. One example of the second acquisition unit 11 is a design unit 190, which will be described later.

For each of the first requirements, the replacement unit 12 replaces a requirement corresponding to a first element or a first relationship with a quantitative requirement corresponding to a second element or a second relationship, based on rule information. The rule information is information defining a rule for replacing a first element or a first relationship between elements with one or more second elements or a second relationship between elements. The first element or the first relationship between elements is information defined in a first format (e.g., an abstract format) regarding the configuration of the first information communication system. The one or more second elements or second relationship between elements is information defined in a second format (e.g., a concrete format). One example of the rule information is reification rule information 191, which will be described later. One example of the replacement unit 12 is a design unit 190, which will be described later.

According to this configuration, abstract elements and relationships included in the first requirements can be replaced with concrete elements and relationships.

The information processing apparatus 1 further includes a coefficient adjustment unit 13. The coefficient adjustment unit 13 normalizes or calculates weighting coefficients for quantitative requirements based on correlation information between configuration proposal information corresponding to combinations of weighting coefficients for quantitative requirements and evaluation values of the configuration proposal information. One example of the correlation information is weight-evaluation value correlation data 177, which will be described later. Specifically, the coefficient adjustment unit 13 uses a second artificial intelligence to normalize or calculate weighting coefficients for quantitative requirements. The second artificial intelligence is an artificial intelligence trained based on correlation information between configuration proposal information corresponding to combinations of weighting coefficients for quantitative requirements and evaluation values of the configuration proposal information. One example of the second artificial intelligence is a coefficient adjustment AI 900, which will be described later.

According to this configuration, even if weighting coefficients for quantitative requirements have not been normalized or are not defined, the weights of quantitative requirements can be normalized or calculated.

### First Example Embodiment

### [System Configuration]

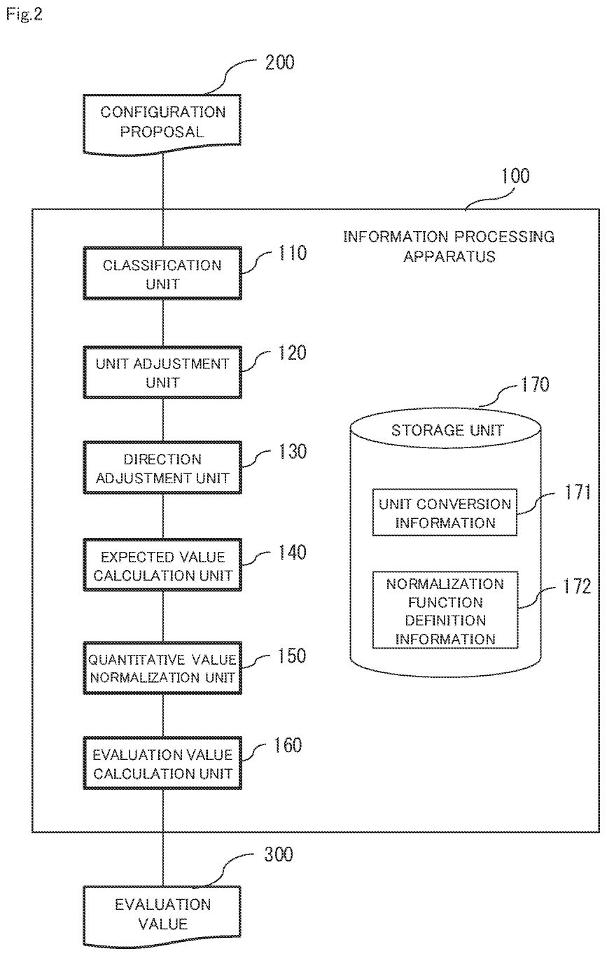

Next, the configuration of the information processing apparatus 1 according to an example embodiment will be described in more detail with reference to FIG. 2. The following describes an example of an information processing apparatus 100 according to a first example embodiment, which is one example embodiment of the present invention.

FIG. 2 is a block diagram showing an example of the configuration of the information processing apparatus according to the first example embodiment. The information processing apparatus 100 according to the first example embodiment includes a quantitative requirement classification unit 110, a unit adjustment unit 120, a direction adjustment unit 130, an expected value calculation unit 140, a quantitative value normalization unit 150, an evaluation value calculation unit 160, and a storage unit 170. The information processing apparatus 100 receives a configuration proposal 200 as input, and outputs an evaluation value 300.

The configuration proposal 200 is definition information regarding components included in an ICT system and the connection relationships between such components. Examples of the components include application software, an OS (Operation System), a server, and a router. Below, application software is sometimes referred to as an “application”. Also, an ICT system is sometimes simply referred to as a “system”.

The quantitative requirement classification unit 110 receives a list of quantitative requirements included in the configuration proposal 200 as input. The quantitative requirement classification unit 110 classifies the input quantitative requirements by type based on the values of predetermined fields of the input quantitative requirements, and generates a list of quantitative requirements classified by type.

The unit adjustment unit 120 receives, as input, the list of classified quantitative requirements output from the quantitative requirement classification unit 110. The unit adjustment unit 120 unifies the units of the quantitative values to be optimized in the received quantitative requirements into reference units by performing conversion processing defined in advance for each type of quantitative requirement. The unit conversion processing is executed by referring to unit conversion information 171 necessary for processing for conversion between units, which is defined in the storage unit 170. Furthermore, when performing unit conversion processing on a quantitative requirement that includes a quantitative value for which an upper limit value and a lower limit value are defined, the unit adjustment unit 120 also performs unit conversion processing on the upper limit value and the lower limit value. The unit adjustment unit 120 generates a list of quantitative requirements that have undergone unit conversion processing (i.e., have undergone unit adjustment), and inputs the list to the direction adjustment unit 130.

The direction adjustment unit 130 receives, as input from the unit adjustment unit 120, the list of quantitative requirements whose quantitative values have undergone unit adjustment, and unifies the directions of optimization of the quantitative values into a single direction. Furthermore, in the case of performing optimization direction adjustment processing on a quantitative requirement that includes a quantitative value in which an upper limit value and a lower limit value are defined, the direction adjustment unit 130 also performs conversion processing on the upper limit value and the lower limit value. The direction adjustment unit 130 generates a list of quantitative requirements whose optimization directions have been unified (i.e., whose optimization directions have been adjusted), and inputs the list to the expected value calculation unit 140.

The expected value calculation unit 140 receives, as input from the direction adjustment unit 130, the configuration proposal 200 and the list of quantitative requirements whose optimization directions have been adjusted. The expected value calculation unit 140 uses artificial intelligence (AI) to calculate expected values of the quantitative values of the quantitative requirements included in the configuration proposal 200, based on the configuration proposal 200 and the list of quantitative requirements whose optimization directions have been adjusted. The expected value calculation unit 140 generates a list of quantitative requirements (whose units and optimization directions have been adjusted) that includes the calculated expected values, and inputs the list to the quantitative value normalization unit 150.

The quantitative value normalization unit 150 receives, as input from the quantitative value normalization unit 150, the expected values of the quantitative values of the quantitative requirements whose units and optimization directions have been adjusted. The quantitative value normalization unit 150 applies normalization function definition information 172 to the expected values of the quantitative values of the quantitative requirements calculated by the expected value calculation unit 140, so as to normalize the magnitudes of the quantitative values to values in a certain range.

The evaluation value calculation unit 160 calculates an evaluation value of the configuration proposal 200 using the normalized expected values of the quantitative value of the quantitative requirements output by the quantitative value normalization unit 150 and the weights of the quantitative requirements, and outputs the result as an evaluation value 300 to the output device. Examples of the output device include a storage device (including a built-in storage device or an external storage device), a display device, a printer, a communication interface, another computer, and a data writer capable of writing to a storage medium.

The storage unit 170 stores the unit conversion information 171 and the normalization function definition information 172. The unit conversion information 171 is information for conversion between units of the quantitative values of the quantitative requirements used by the unit adjustment unit 120. The normalization function definition information 172 is information regarding quantitative value normalization functions used by the quantitative value normalization unit 150.

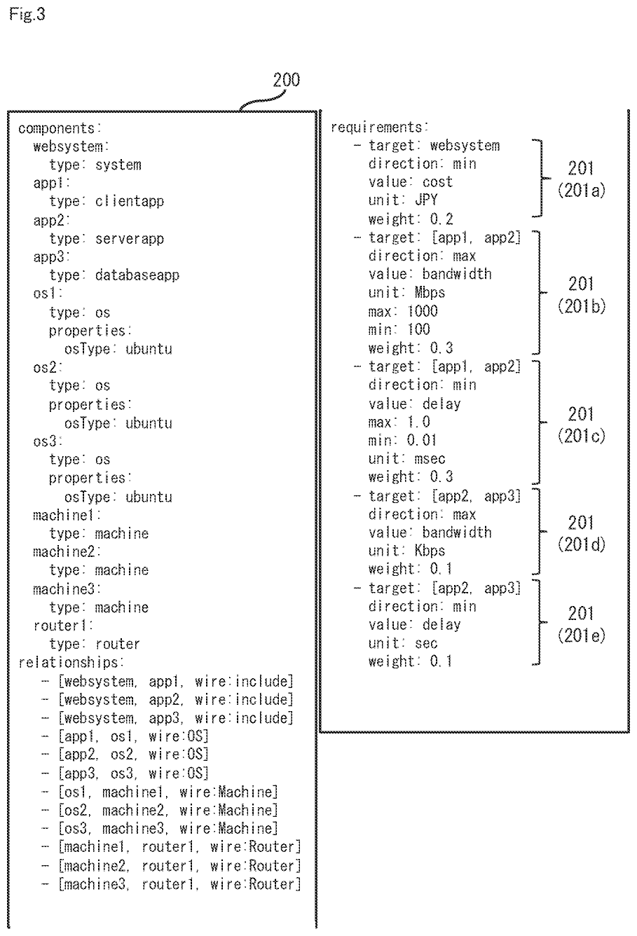

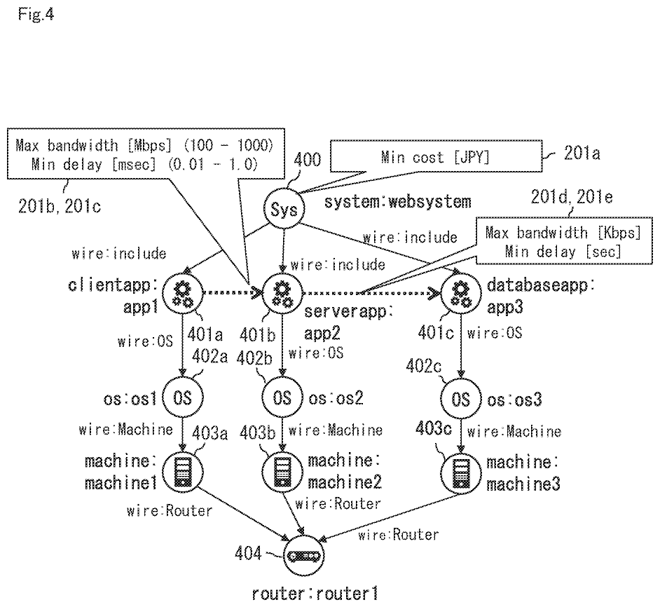

FIG. 3 is a diagram illustrating an example of content of the configuration proposal 200 according to the first example embodiment. Also, FIG. 4 is a diagram in which the content of the configuration proposal 200 shown in FIG. 3 is visually expressed using a graph structure. The configuration proposal shown in FIGS. 3 and 4 represents, for example, configuration information regarding a web application system configured by three types of applications, namely a client application, a server application, and a database application.

The definition data for the configuration proposal 200 shown in FIG. 3 includes three fields, namely “components” which defines components, “relationships” which defines relationships between components, and “requirements” which defines quantitative requirements such as system performance and cost.

In the graph structure block diagram shown in FIG. 4, “components” correspond to nodes, “relationships” correspond to solid-line arrow edges, and “requirements” correspond to bold dashed-line arrow edges and speech boxes.

In FIG. 4, the component (node) related to the system is denoted by the reference sign 400. Also, the components (nodes) related to applications are denoted by reference signs 401a, 401b, and 401c. Also, the components (nodes) related to the operating system (OS) are denoted by reference signs 402a, 402b, and 402c. Furthermore, the components (nodes) related to machines (e.g., physical servers, virtual servers, and client terminals) are denoted by reference signs 403a, 403b, and 403c. Also, the component (node) related to the router is denoted the reference sign 404.

In FIG. 3, the definition of a component described in the “components” field may include “type” information regarding the type of the component, and “properties” information regarding attribute values. A relationship described in the “relationships” field is defined by a list made up of a set of three pieces of information, namely the component that is the relationship request source, the component that is the relationship request destination, and relationship type information. For example, the relationship “[websystem, app1, wire:include]” indicates that the component websystem 400 representing a system is connected to the component app1 401a representing an application of the system by the relationship “wire:include” representing a dependent relationship.

Each quantitative requirement described in the “requirements” field is defined by a list including at least five pieces of information, namely “target”, “direction”, “value”, “unit”, and “weight”. In FIG. 3, five quantitative requirements 201a, 201b, 201c, 201d, and 201e are defined. Hereinafter, the quantitative requirements 201a, 201b, 201c, 201d, and 201e may sometimes be collectively referred to as the quantitative requirements 201.

Here, “target” is a quantitative requirement that represents the component or the relationship that is the target of the quantitative requirement. Also, “direction” is a quantitative requirement that represents the direction of optimization of a quantitative value. Also, “value” is a quantitative requirement that represents the quantitative value that is to be optimized. Also, “unit” is a quantitative requirement that represents the unit of the quantitative value. Also, “weight” is a quantitative requirement that represents the weight between quantitative requirements.

For example, the quantitative requirement 201a described in the “requirements” field in FIG. 3 indicates that the overall cost of the system is to be minimized. Specifically, according to the quantitative requirement 201a, the quantitative value “cost”, which indicates the cost of the component “websystem”, is to be minimized, the unit of the quantitative value is “JPY”, which represents Japanese yen, the optimization direction is “min”, which indicates minimization, and the weight of the quantitative requirement is 0.2.

Furthermore, the quantitative requirements 201 may include a definition of an upper limit value of the quantitative value that the user requests of the system, a lower limit value of the quantitative value, or both an upper limit value and a lower limit value of the quantitative value. In the example in FIG. 3, in the quantitative requirements 201b and 201c, the fields “max” and “min”, which respectively indicate the upper limit value and the lower limit value of the quantitative value, are defined. As another example, in the quantitative requirement 201b, in order to maximize the bandwidth, 100 [Mbps] is defined as the lower limit value that needs to be satisfied, and 1000 [Mbps] (megabits per second) is defined as the upper limit value at which performance is considered to be sufficient performance.

In the configuration proposal shown in FIGS. 3 and 4, the fact that a websystem 400 is configured by three applications, namely an app1 401a, an app2 401b, and an app3 401c is defined by the relationship “wire:include”, which represents the correspondence between the system and the applications. The websystem 400 is a “system” element, which represents an ICT system. The app1 401a is a “clientapp” element, which represents a client application. The app2 401b is a “serverapp” element, which represents a server application. The app3 401c is a “databaseapp” element, which represents a database application.

The fact that applications (401a, 401b, 401c) are respectively hosted on “os” elements (402a, 402b, 402c), which represent an OS, is defined by the relationship “wire:OS”. The definitions of the “os” elements include the attribute value “osType:ubuntu”, which indicates that the type of OS is Ubuntu (registered trademark), which is a Linux (registered trademark) OS. Also, the fact that OSes (402a, 402b, 402c) are respectively hosted on “machine” components (403a, 403b, 403c), which represent a physical server, is defined by the relationship “wire:Machine”. Furthermore, the fact that servers (403a, 403b, 403c) are connected to the same router1 404, which is a router component, is defined by the relationship “wire:Router”.

In the quantitative requirement 201a, the minimization of the cost [JPY] of the overall system (websystem 400) is defined. In the quantitative requirements 201b and 201c, the maximization of the communication bandwidth [Mbps] and the minimization of the delay [msec] (milliseconds) between app1 (401a) and app2 (401b) are defined. In the quantitative requirements 201d and 201e, the maximization of the communication bandwidth [Kbps] (kilobits per second) and the minimization of the delay [sec] (seconds) between app2 (401b) and app3 (401c) are defined.

Note that the definition of the configuration proposal 200 may include attribute values of components such as application and OS setting information, as well as information regarding quantitative requirements that need to be verified.

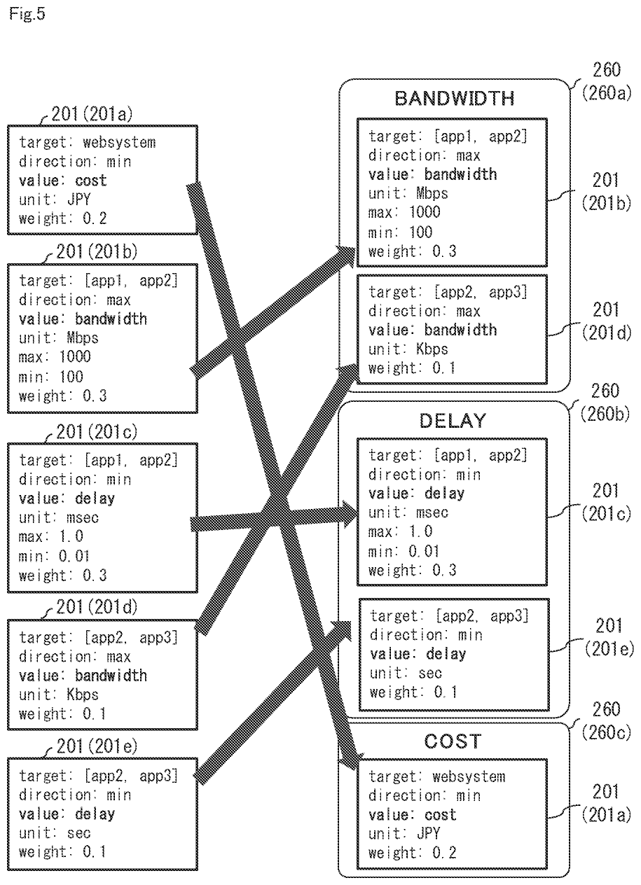

Next, the quantitative requirement classification unit 110 will be described in detail. FIG. 5 is a diagram illustrating an example of quantitative requirement classification processing performed by the quantitative requirement classification unit according to the first example embodiment. FIG. 5 illustrates an example of classifying the quantitative requirements defined in the configuration proposal shown in FIGS. 3 and 4. The quantitative requirement classification unit 110 identifies the type of each of the quantitative requirements 201a, 201b, 201c, 201d, and 201e based on the value in the field “value”, which indicates the quantitative value that is to be optimized, included in the definitions of the quantitative requirements 201a, 201b, 201c, 201d, and 201e. The quantitative requirement classification unit 110 classifies the quantitative requirements 201a, 201b, 201c, 201d, and 201e based on the resulting identified types. The quantitative requirement classification unit 110 generates lists 260 (260a, 260b, 260c) of the quantitative requirements 201a, 201b, 201c, 201d, and 201e classified by type. The generated lists 260 (260a, 260b, 260c) of the quantitative requirements 201a, 201b, 201c, 201d, and 201e are input to the unit adjustment unit 120.

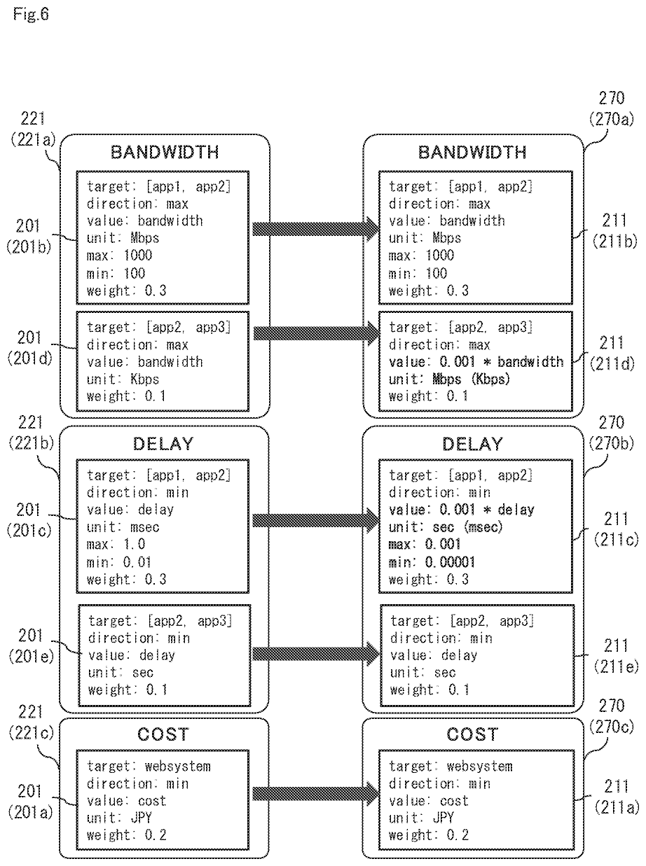

Next, the unit adjustment unit 120 will be described in detail. FIG. 6 is a diagram illustrating an example of quantitative unit conversion processing for converting the unit of a quantitative value of a quantitative requirement, which is performed by the unit adjustment unit according to the first example embodiment. FIG. 6 illustrates an example of performing unit conversion processing on the generated lists 260 (260a, 260b, 260c) of the classified quantitative requirements 201a, 201b, 201c, 201d, and 201e shown in the example in FIG. 5.

Conversion processing is predefined for each type of quantitative requirement, and the unit adjustment unit 120 performs corresponding conversion processing on the unit of the quantitative value to be optimized in each of the received quantitative requirements 201 (201a, 201b, 201c, 201d, 201e). Accordingly, the units of the quantitative values to be optimized can be unified into reference units.

The unit adjustment unit 120 performs unit conversion processing on the lists 260 (260a, 260b, 260c) of the classified quantitative requirements 201 (201a, 201b, 201c, 201d, 201e) based on the unit conversion information 171. Accordingly, lists 270 (270a, 270b, 270c) of the quantitative requirements 211 (211a, 211b, 211c, 211d, 211e), which have undergone unit conversion processing, are obtained.

In the lists 270 of the quantitative requirements 211 that have undergone unit conversion processing, the bold descriptions in the input quantitative requirements indicate the definition items that were changed due to the unit conversion processing. In the quantitative requirement 211c, in the “unit” field representing the unit of the quantitative value, information indicating the unconverted unit is shown in parentheses after the converted unit. In the quantitative requirements 211c and 211d, in the “value” field, which represents the quantitative value item, it is defined that the quantitative value to be calculated later by the expected value calculation unit 140 is to be multiplied by a coefficient for unit conversion. Likewise, the upper limit value and the lower limit value of the quantitative value defined in the quantitative requirement are also to be multiplied by the coefficient for unit conversion. For example, the description “value:0.001*bandwidth” means that the quantitative value of the bandwidth to be calculated later is to be multiplied by 0.001. Also, the description “unit:Mbps (Kbps)” means that when calculating the evaluation value of the configuration proposal, the unit of the bandwidth value is to be converted from the unit “Kbps”, which is originally defined in the quantitative requirement, to the unit “Mbps”.

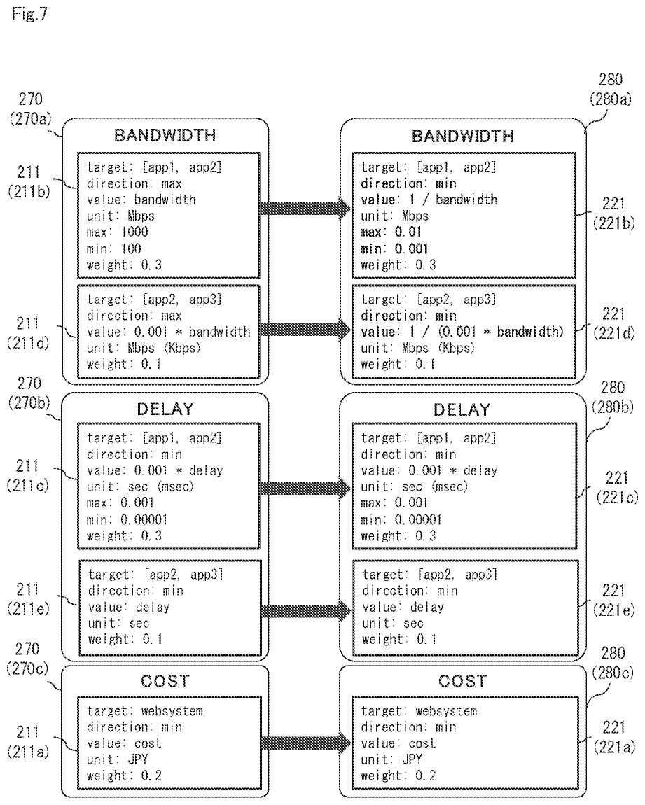

Next, the direction adjustment unit 130 will be described in detail. FIG. 7 is a diagram illustrating an example of processing for adjusting the direction of optimization of quantitative requirements performed by the direction adjustment unit according to the first example embodiment. FIG. 7 illustrates an example in which the direction adjustment unit 130 performs quantitative value optimization direction adjustment processing on the lists 270 of the quantitative requirements 211 (211a, 211b, 211c, 211d, 211e) whose quantitative values underwent unit adjustment, which were generated by the unit adjustment unit 120 and are shown in the example in FIG. 6.

The direction adjustment unit 130 receives, as input, a list of quantitative requirements whose quantitative values underwent unit adjustment, which is output from the unit adjustment unit 120. The direction adjustment unit 130 unifies the directions of optimization of quantitative values into a single direction in the list of quantitative requirements whose quantitative values underwent unit adjustment. When performing optimization direction adjustment processing on a quantitative requirement that includes a quantitative value for which an upper limit value and a lower limit value are defined, the direction adjustment unit 130 also performs the conversion processing on the upper limit value and the lower limit value. The direction adjustment unit 130 generates a list of quantitative requirements whose optimization directions have been unified, and inputs the list to the expected value calculation unit 140.

In the example in FIG. 7, the direction adjustment unit 130 first refers to a “direction” field that defines a quantitative value optimization direction for each of the quantitative requirements 211 (211a, 211b, 211c, 211d, and 211e). Next, the direction adjustment unit 130 specifies whether the value “max” indicating quantitative value maximization is defined in more of the quantitative requirements or whether the value “min” indicating quantitative value minimization is defined in more of the quantitative requirements, and determines that the optimization directions are to be unified to the specified value that is included in more quantitative requirements. In the example in FIG. 7, “direction:max” is defined in the two quantitative requirements 211b and 211d, and “direction: min” is defined in the three quantitative requirements 211a, 211c, and 211e. Therefore, in this case, the quantitative value optimization directions are unified to “direction:min”. Note that in the case where the number of quantitative requirements in which the value “max” indicating quantitative value maximization is defined is the same as the number of quantitative requirements in which the value “min” indicating quantitative value minimization is defined, the direction adjustment unit 130 may unify the optimization directions to either of the directions.

Then, the direction adjustment unit 130 performs optimization direction adjustment and quantitative value conversion processing on the quantitative requirements 221b and 221d regarding bandwidth constraints. Specifically, since maximization of the bandwidth value is equivalent to minimization of the reciprocal of the bandwidth value, the direction adjustment unit 130 converts the value of the “direction” field from “max” to “min”. Also, since maximization of the bandwidth value is equivalent to minimization of the reciprocal of the bandwidth value, the direction adjustment unit 130 changes the values of the “value” field from “bandwidth” and “0.001*bandwidth” to “1/bandwidth” and “1/(0.001*bandwidth)”.

Also, when performing direction adjustment processing on a quantitative requirement that includes a quantitative value for which an upper limit value and a lower limit value are defined, the direction adjustment unit 130 converts the reciprocal of the upper limit value to the lower limit value, and converts the reciprocal of the lower limit value to the upper limit value.

Lists 280 (280a, 280b, 280c) of the quantitative requirements 211 (211a, 211b, 211c, 211d, 211e) that have undergone direction adjustment processing are input to the expected value calculation unit 140.

Next, the expected value calculation unit 140 will be described in detail. The expected value calculation unit 140 receives, as input, the configuration proposal 200 and the lists 280 of the quantitative requirements 211 whose optimization directions have been adjusted, which are output from the direction adjustment unit 130. Then, the expected value calculation unit 140 uses an AI to calculate expected values of the quantitative values of the quantitative requirements included in the configuration proposal. The expected value calculation unit 140 generates a list of calculated expected values, and inputs the list to the quantitative value normalization unit 150.

As an example of the AI, it is possible to use an AI that uses the design technology disclosed in Non-Patent Document 1 and learns quantitative requirements regarding the configuration of a system (hereinafter referred to as a quantitative requirement AI). The quantitative requirement AI learns the relationship that quantitative requirements included in a configuration proposal have with actual quantitative values calculated by verification, examples of which include cost estimation and the performance measurement (e.g., bandwidth and delay), performed on a system constructed in an actual environment based on the configuration proposal. This makes it possible to calculate expected values of quantitative values at locations specified by quantitative requirements in a configuration proposal.

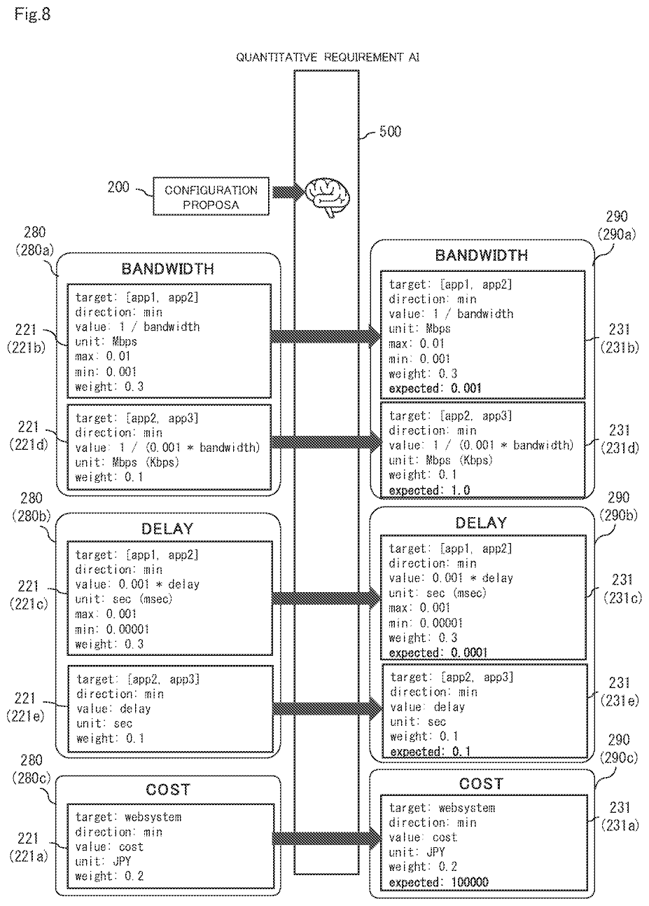

FIG. 8 is a block diagram illustrating an example of processing for calculating expected values of quantitative values, which is performed by the expected value calculation unit according to the first example embodiment. In FIG. 8, an example is illustrated in which processing for calculating expected values of the quantitative values of quantitative requirements is performed by the quantitative requirement AI 500. The definition information of the configuration proposal 200 and the lists 280 of the quantitative requirements 221 are input to the quantitative requirement AI 500. The quantitative requirement AI 500 calculates expected values of the quantitative values predicted for the quantitative requirements based on information such as the graph structure and the components of the configuration proposal.

In the example in FIG. 8, the variable conversion processing specified in the “value” field is performed on the expected values of the quantitative values calculated by the quantitative requirement AI 500. As a result, the numerical values that are stored in the “expected” field are numerical values of expected values that take into account the unit conversion processing performed by the unit adjustment unit 120 and the variable conversion processing that accompanies the optimization direction adjustment performed by the direction adjustment unit 130. For example, in the case of the quantitative requirement 221d regarding bandwidth shown in FIG. 8, it is assumed that “1000 [Kbps]” is calculated by the quantitative requirement AI 500 as the predicted value of the bandwidth performance between the two components app2 and app3. The numerical value “1.0” calculated by substituting the predicted value into the variable “bandwidth” included in the value defined in the “value” field is stored in the “expected” field as the expected value that has undergone unit adjustment and optimization direction adjustment.

Next, the quantitative value normalization unit 150 will be described in detail. The quantitative value normalization unit 150 applies the normalization function definition information 172 stored in the storage unit 170 to the expected values of the quantitative values of the quantitative requirements calculated by the expected value calculation unit 140, so as to normalize the magnitudes of the quantitative values to values within a certain range. A normalization function is defined for each type of quantitative requirement, unit of quantitative value, and direction of optimization, and a corresponding normalization function is applied to each input quantitative requirement.

The quantitative value normalization unit 150 may also include an AI that learns a set of four values including a configuration proposal, a quantitative requirement, the normalization function applied to the quantitative requirement, and an evaluation value of the configuration proposal calculated by the evaluation value calculation unit 160 (hereinafter referred to as normalization function AI).

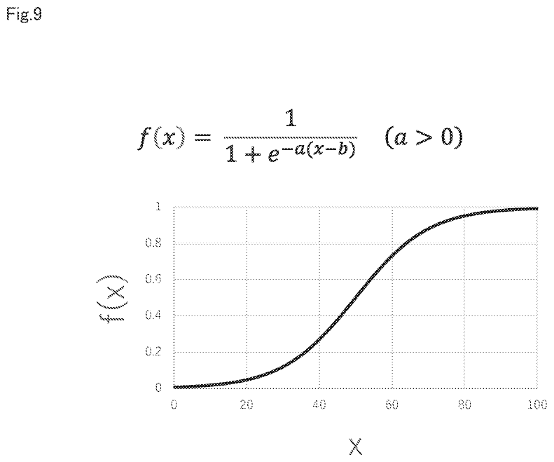

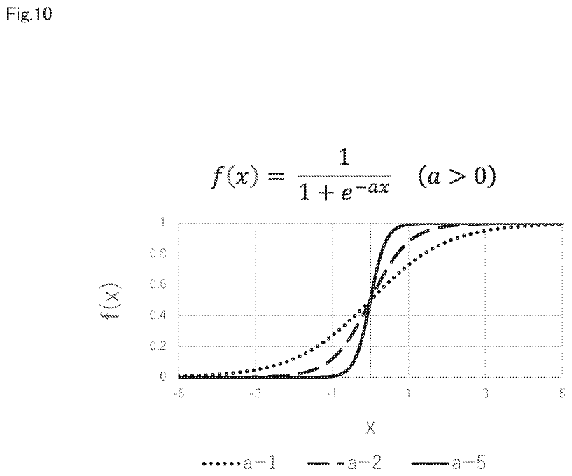

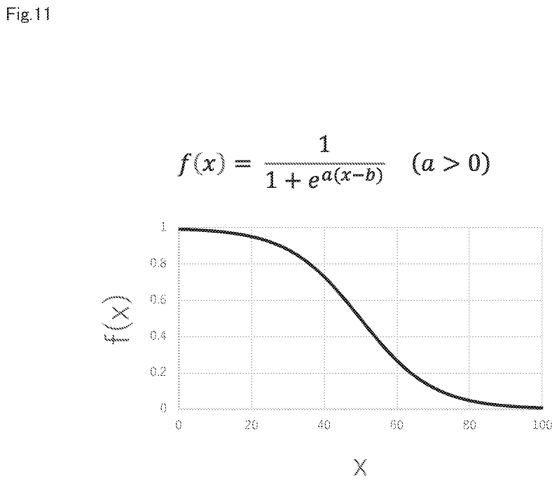

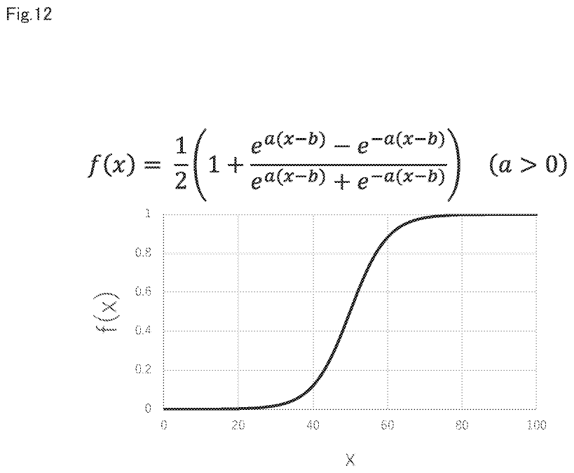

FIG. 9 is a graph showing an example of a normalization function fmax(x) according to the first example embodiment. FIG. 10 is a graph showing an example of a sigmoid function S(x) according to the first example embodiment. FIG. 11 is a graph showing an example of a normalization function fmin(x) according to the first example embodiment. FIG. 12 is a graph showing an example of a normalization function f(x) according to the first example embodiment. These normalization functions and other functions will be described below with reference to these graphs.

In the first example embodiment, the following Expression (1) and the function fmax(x) shown in FIG. 9 are used as examples of normalization functions.

$$\begin{matrix}[ Math 1 ] & \\ {f}_{max} ( x ) = \frac{1}{1 + {e}^{- a ( x - b )}} ( a > 0 ) & ( 1 )\end{matrix}$$

The function in Expression (1) is obtained by the sigmoid function S(x), which is shown in Expression (2) and is used to normalize the magnitudes of numerical values in the field of machine learning, being translated by the amount b in the x-axis direction. FIG. 10 illustrates a graph of the sigmoid function for three values of the coefficient a. The sigmoid function monotonically increases with respect to the variable x, is distributed in the value range from 0 to 1, and has the characteristics of a point-symmetric graph at the coordinates (0, 0.5). The coefficient a is a positive parameter used to adjust the slope of the sigmoid function, and the smaller the value is, the gentler the curve is, whereas the larger the value is, the steeper the curve is.

$$\begin{matrix}[ Math 2 ] & \\ S ( x ) = \frac{1}{1 + {e}^{- a x}} ( a > 0 ) & ( 2 )\end{matrix}$$

In the case of “max”, which represents that the direction of optimization of a quantitative requirement is maximization, the function fmax(x) shown in Expression (1) is used. Also, in the case of “min”, which represents that the direction of optimization of a quantitative requirement is minimization, the function fmin(x) shown in FIG. 11 and Expression (3), which is obtained by inverting the function fmax(x) in the x-axis direction at x=b, is used.

$$\begin{matrix}[ Math 3 ] & \\ {f}_{min} ( x ) = \frac{1}{1 + {e}^{a ( x - b )}} ( a > 0 ) & ( 3 )\end{matrix}$$

In the case where an upper limit value and a lower limit value are defined for the quantitative value of a quantitative requirement, the coefficients of the normalization function represented by a and b in Expressions (1) and (3) are set such that the value of the normalization function varies in the domain where the variable x ranges from the lower limit value to the upper limit value. In the case where an upper limit value and a lower limit value are defined for the quantitative value of a quantitative requirement, the coefficients of the normalization function represented by a and b in Expressions (1) and (3) are set such that x converges to a constant value within the range where x falls below the lower limit value or x exceeds the upper limit value. For example, in the example of the normalization function fmax(x), which is a monotonically increasing function, if the lower limit value x0 and upper limit value x1 have been set, then the coefficients a and b are set such that fmax(x0)=0.0001 and fmax(x1)=0.9999.

Note that besides the sigmoid function, the function f(x) shown in Expression (4) and FIG. 12, which applies the tanh (Hyperbolic tangent) function, or the like can also be applied as the normalization function, and the normalization function is not limited to the description given above.

$$\begin{matrix}[ Math 4 ] & \\ f ( x ) = \frac{1}{2} ( 1 + \frac{{e}^{a ( x - b )} - {e}^{- a ( x - b )}}{{e}^{a ( x - b )} + {e}^{- a ( x - b )}} ) ( a > 0 ) & ( 4 )\end{matrix}$$

Also, the normalization function AI may perform machine learning in advance using the following four values as training data, and determine, based on the learning results, normalization functions that correspond to the expected values of the quantitative values of quantitative requirements input to the quantitative value normalization unit 150. The four values are a configuration proposal, a quantitative requirement included in the configuration proposal, the normalization function used to normalize the expected value of the quantitative requirement, and the evaluation value of the configuration proposal calculated using the normalization function.

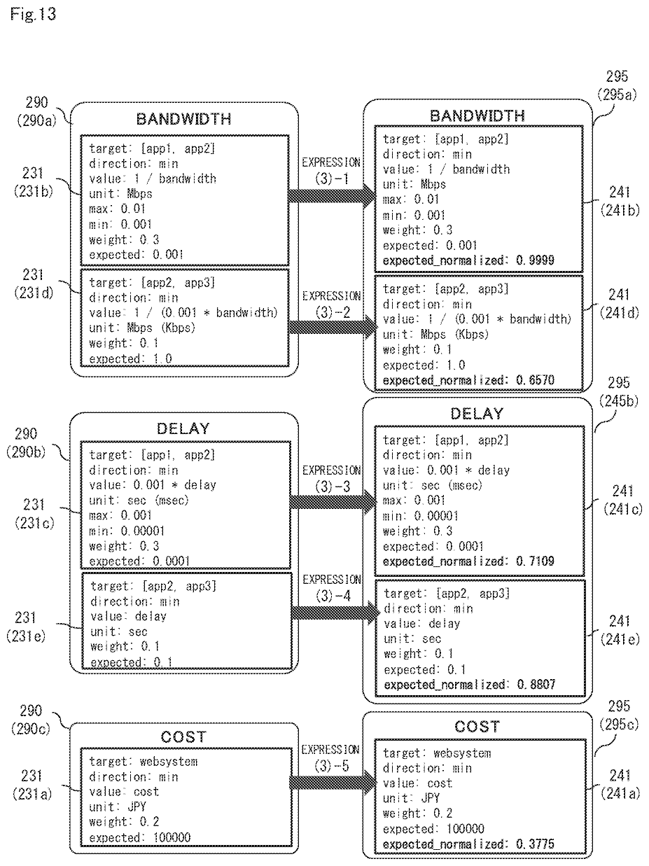

FIG. 13 is a block diagram illustrating an example of quantitative value normalization processing performed by the quantitative value normalization unit according to the first example embodiment. FIG. 13 illustrates an example of processing for normalizing the quantitative value of an input quantitative requirement in the quantitative value normalization unit 150. In the example in FIG. 13, the quantitative value normalization unit 150 receives, as input, lists 290 of quantitative requirements 231 that include expected values of quantitative values, which are output from the expected value calculation unit 140 and shown in FIG. 9. The quantitative value normalization unit 150 reads the function fmin(x) shown in Expression (3) and FIG. 11 from the normalization function definition information 172 as the normalization function that corresponds to the types of the quantitative requirements 231 and the directions of optimization of the quantitative values. The quantitative value normalization unit 150 calculates normalized expected values by substituting the expected values defined in the “expected” field into the variable x in the read function fmin(x).

The following Expressions (3)-1 to (3)-5 are expressions in which the coefficients a and b, which are used in the normalization function that corresponds to the types of the quantitative requirements 231 and the directions of optimization of the quantitative values and was acquired from the normalization function definition information 172, have been set such that the value of the normalization function varies in the domain where the variable x ranges from the lower limit value to the upper limit value.

$$\begin{matrix}[ Math 5 ] & \\ {f}_{min} ( x ) = \frac{1}{1 + {e}^{10 ( x - 1.0 )}} & ( 3 ) ‐ 1\end{matrix}$$

$$\begin{matrix}[ Math 6 ] & \\ {f}_{min} ( x ) = \frac{1}{1 + {e}^{0.1 ( x - 7.5 )}} & ( 3 ) ‐ 2\end{matrix}$$

$$\begin{matrix}[ Math 7 ] & \\ {f}_{min} ( x ) = \frac{1}{1 + {e}^{100 ( x - 0.01 )}} & ( 3 ) ‐ 3\end{matrix}$$

$$\begin{matrix}[ Math 8 ] & \\ {f}_{min} ( x ) = \frac{1}{1 + {e}^{10 ( x - 0.3 )}} & ( 3 ) ‐ 4\end{matrix}$$

$$\begin{matrix}[ Math 9 ] & \\ {f}_{min} ( x ) = \frac{1}{1 + {e}^{0.00001 ( x - 50000 )}} & ( 3 ) ‐ 5\end{matrix}$$

The calculated values are stored in the “expected_normalized” field, which indicates the normalized expected value, in quantitative requirements 241 (241a, 241b, 241c, 241d, 241e). Lists 295 (295a, 295b, 295c) of the normalized quantitative requirements 241 (241a, 241b, 241c, 241d, 241e) are input to the evaluation value calculation unit 160.

Next, the evaluation value calculation unit 160 will be described in detail. The evaluation value calculation unit 160 calculates a configuration proposal evaluation value using the expected values of the normalized quantitative values of the quantitative requirements 241 output by the quantitative value normalization unit 150, and using the weights of the quantitative requirements 241, and outputs the result as an evaluation value 300.

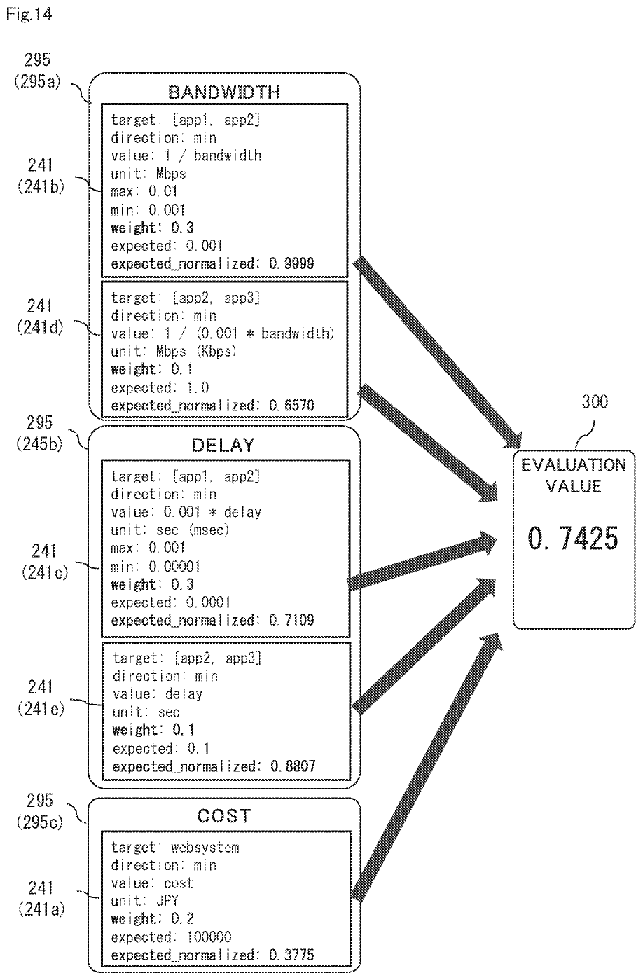

FIG. 14 is a diagram illustrating an example of evaluation value calculation processing performed by the evaluation value calculation unit 160 according to the first example embodiment. In the example in FIG. 14, the evaluation value calculation unit 160 receives, as input, quantitative requirement lists 295 that include the expected values of the quantitative values of the normalized quantitative requirements 241 output from the quantitative value normalization unit 150 in the example in FIG. 13. The evaluation value calculation unit 160 calculates the configuration proposal evaluation value 300 by calculating the sum (linear weighted sum) of values obtained multiplying the normalized expected value defined in the “expected_normalized” field of each of the quantitative requirements 241 by the corresponding weight of the quantitative requirement defined in the “weight” field.

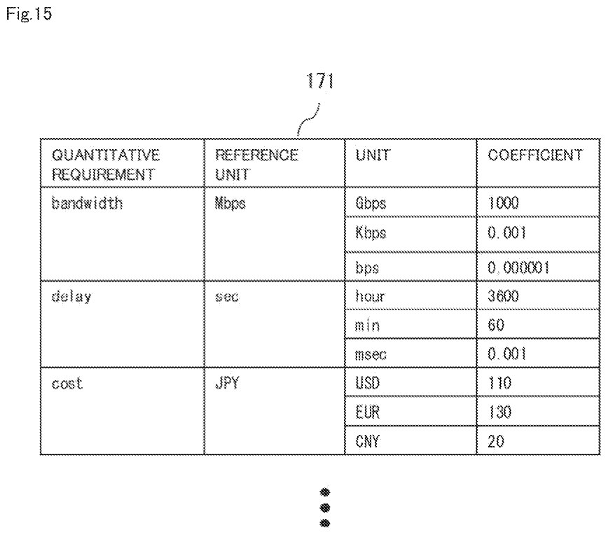

FIG. 15 is a diagram illustrating an example of the unit conversion information 171 according to the first example embodiment. The unit conversion information 171 is defined for each type of quantitative requirement, and includes information regarding a reference unit into which quantitative values are to be unified through unit conversion, and a coefficient by which a quantitative value is to be multiplied in conversion from the original unit to the reference unit. In the example in FIG. 6, in the case of converting the units of the quantitative requirement “bandwidth”, if the reference unit is “Mbps”, it is defined that a quantitative value whose unit is “Gbps” (gigabits per second) is to be multiplied by 1000, a quantitative value whose unit is “Kbps” is to be multiplied by 0.001, and a quantitative value whose unit is “bps” is to be multiplied by 0.000001.

Note that “Mbps” mentioned above means “megabits per second”. “Gbps” means “gigabits per second”. “Kbps” means “kilobits per second”. “bps” means “bits per second”.

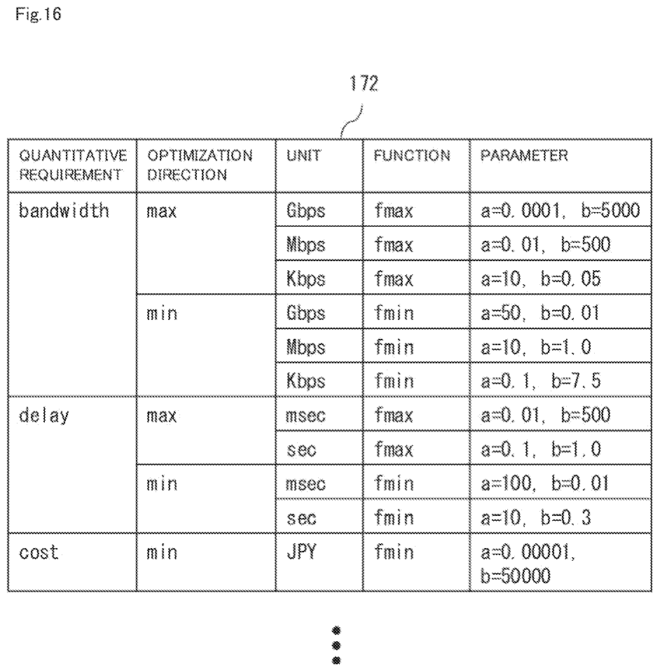

FIG. 16 is a diagram illustrating an example of the normalization function definition information 172 according to the first example embodiment. As shown in the application example in FIG. 13, the normalization function definition information 172 includes quantitative requirement types, quantitative value optimization directions, the normalization functions used for the respective quantitative values, and the parameters used in the normalization functions. The “function” column defines the names of the optimization functions shown as examples in Expressions (1), (3), and (4), for example. The “parameter” column defines pairs of a variable and a substituted value, which are parameters of the corresponding normalization function in the “function” column.

### [System Operation]

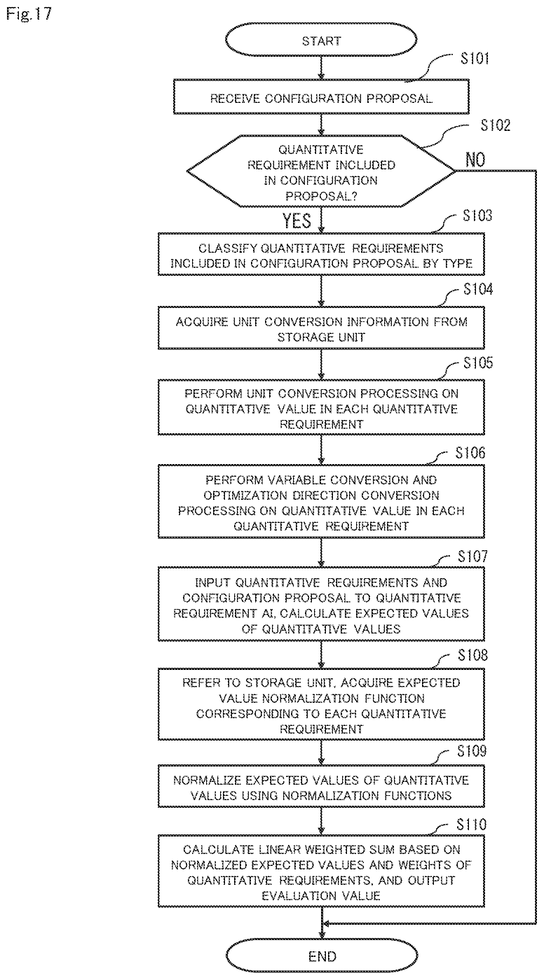

Next, overall operation in the present example embodiment will be described in detail with reference to the flowchart in FIG. 17. FIG. 17 is a flowchart showing operation of the information processing apparatus according to the first example embodiment. First, the configuration proposal 200 is input to the quantitative requirement classification unit 110 (step S101).

The quantitative requirement classification unit 110 determines whether quantitative requirements are included in the input configuration proposal 200 (step S102). If no quantitative requirement is included in the configuration proposal 200, the quantitative requirement classification unit 110 determines that an evaluation value cannot be calculated for the configuration proposal 200, and ends operation. If quantitative requirements are included in the configuration proposal, the quantitative requirement classification unit 110 classifies the quantitative requirements 201 by type, and inputs the quantitative requirements to the unit adjustment unit 120 (step S103).

The unit adjustment unit 120 refers to the unit conversion information 171 stored in the storage unit 170 (step S104). The unit adjustment unit 120 uses the unit conversion information 171 to perform unit conversion on the quantitative values that are to be optimized in the input quantitative requirements 201. The unit adjustment unit 120 inputs the quantitative requirements 211 that have undergone quantitative value conversion to the direction adjustment unit 130 (step S105).

The direction adjustment unit 130 unifies the directions of optimization of the quantitative values defined in the input quantitative requirements 211 into the same direction. For each of the quantitative requirements 211, the direction adjustment unit 130 performs variable conversion and optimization direction conversion on the quantitative value as necessary. The direction adjustment unit 130 outputs the quantitative requirements 221 that have undergone optimization direction adjustment to the expected value calculation unit 140 (step S106).

Next, the expected value calculation unit 140 inputs the quantitative requirements 221 and the configuration proposal 200 to the quantitative requirement AI 500, and calculates expected value of the quantitative values of the quantitative requirements 221. The expected value calculation unit 140 inputs the quantitative requirements 231 for which expected values were calculated for the quantitative values to the quantitative value normalization unit 150 (step S107).

The quantitative value normalization unit 150 refers to the storage unit 170 and acquires the normalization function that corresponds to the quantitative requirements (step S108). The quantitative value normalization unit 150 calculates normalized expected values for the input quantitative requirements by inputting the expected values of the quantitative values into the normalization function. The quantitative value normalization unit 150 inputs the normalized expected values to the evaluation value calculation unit 160 (step S109).

The evaluation value calculation unit 160 calculates a linear weighted sum using the normalized expected values of the input quantitative requirements and weights of the quantitative requirements. The evaluation value calculation unit 160 outputs the calculation result as the evaluation value of the configuration proposal, and ends operation (step S110).

### Effects of First Example Embodiment

As described above, according to the first example embodiment, quantitative value unit adjustment and optimization direction adjustment can be automatically executed on a plurality of quantitative requirements that need to be evaluated in a system configuration proposal, and it is possible to automatically calculate an evaluation value of the configuration proposal that takes the quantitative requirements into consideration. This makes it possible to automate configuration proposal evaluation that takes a plurality of quantitative requirements into consideration. As a result, it is possible to significantly reduce the burden on engineers involved in system design that has conventionally required manual adjustment.

### [Program]

The program according to the first example embodiment may be a program that causes a computer to execute the processes described in FIG. 17. By installing this program in a computer and executing the program, the information processing apparatus 100 and the information processing method according to the first example embodiment can be realized. Further, the processor of the computer performs processing to function as the quantitative requirement classification unit 110, the unit adjustment unit 120, the direction adjustment unit 130, the expected value calculation unit 140, the quantitative value normalization unit 150 and the evaluation value calculation unit 160.

Also, the program according to the first example embodiment may be executed by a computer system constructed by a plurality of computers. In this case, for example, each computer may function as any of the quantitative requirement classification unit 110, the unit adjustment unit 120, the direction adjustment unit 130, the expected value calculation unit 140, the quantitative value normalization unit 150 and the evaluation value calculation unit 160.

In the first example embodiment, the storage unit 170 may be realized by storing the data files that comprise them in a hard disk or other storage device provided in a computer, or it may be realized by a storage device in another computer.

### Second Example Embodiment

### [System Configuration]

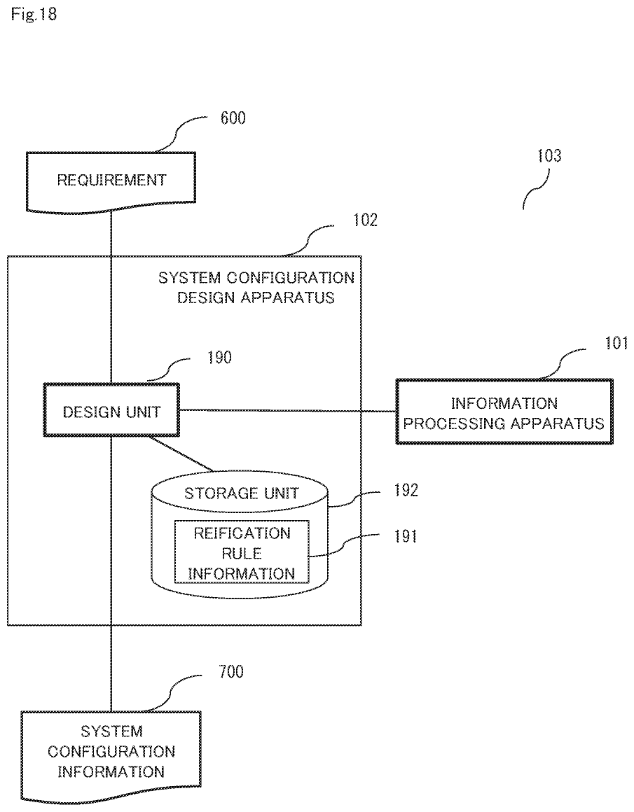

Next, a second example embodiment will be described in detail. FIG. 18 is a block diagram showing an example of the configuration of an information processing apparatus according to the second example embodiment. A system configuration design system 103 according to the second example embodiment includes an information processing apparatus 101 and a system configuration design apparatus 102.

The system configuration design apparatus 102 receives a requirement 600 as input, and outputs system configuration information 700 to an output device. Examples of the output device include a storage device (including a built-in storage device or an external storage device), a display device, a printer, a communication interface, another computer, and a data writer capable of writing to a storage medium. The system configuration design apparatus 102 is the device shown in Non-Patent Document 1, for example, and includes a design unit 190 and a storage unit 192.

The design unit 190 receives the requirement information 600 as input. Hereinafter, the requirement information is sometimes simply referred to as the “requirement”. The requirement 600 is information that abstractly represents components, constraint conditions, and the like regarding the system.

The design unit 190 generates system configuration proposal information (hereinafter simply referred to as a “configuration proposal”) by replacing the abstract elements in the requirement 600 with concrete elements or configurations based on reification rule information 191. By repeatedly applying the reification rule information 191 and replacing abstract elements, the design unit 190 advances in the processing of replacing abstract elements with concrete elements or configurations. The design unit 190 outputs, as the system configuration information 700, a configuration proposal in which abstract elements have been completely replaced with concrete elements or configurations.

The storage unit 192 stores the reification rule information 191. The reification rule information 191 is information that defines rules for converting abstract elements included in requirements and the configuration proposal into concrete elements or concrete configurations.

The information processing apparatus 101 receives the configuration proposal output by the design unit 190 and calculates an evaluation value of the configuration proposal. The information processing apparatus 101 outputs the calculated evaluation value of the configuration proposal to the design unit 190.

Note that, as one example, in the system configuration design system 103 according to the second example embodiment, processing steps are divided between the information processing apparatus 101 and the system configuration design apparatus 102, but the present invention is not limited to this. In other words, one information processing apparatus may have functions executed by the information processing apparatus 101 and functions executed by the system configuration design apparatus 102.

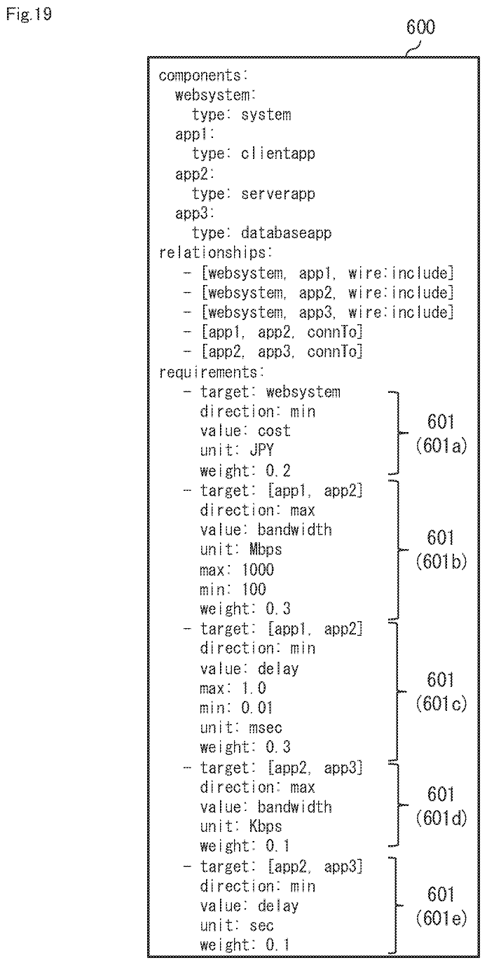

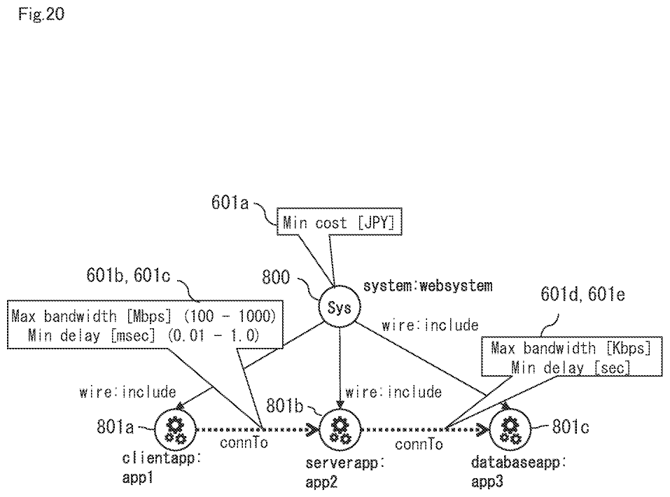

One example of the requirement 600 will be described using FIGS. 19 and 20. FIG. 19 is a diagram illustrating an example of descriptions in the requirement 600 according to the second example embodiment. The descriptions in the requirement 600 in FIG. 19 are one example of definitions of system requirements corresponding to the configuration proposal in FIGS. 3 and 4. FIG. 20 is a diagram in which the content of the requirement 600 shown in FIG. 19 is visually expressed using a graph structure. As shown in FIG. 19, the definitions in requirement 600 may be in the same format as the definitions in the configuration proposal, and the requirement 600 may include information regarding components required of the system by a user, relationships between such components, and quantitative requirements for the system.

In FIG. 20, a websystem 800 is a “system” element, which represents a system. An app1 801a is a “clientapp” element, which represents a client application. An app2 801b is a “serverapp” element, which represents a server application. An app3 801c is a “databaseapp” element, which represents a database application.

In the examples in FIGS. 19 and 20, the fact that the websystem 800 is configured by three applications, namely the app1 801a, the app2 801b, and the app3 801c, is defined by the relationship “wire:include”, which represents the correspondence between the system and the applications. Also, the abstract relationship “connTo”, which indicates that communication can be performed in some sort of way, is defined as the relationship that the app1 801a has with the app2 801b and the relationship that the app2 801b has with the app3 801c.

Also, as shown in FIG. 19, quantitative requirements 601 (601a, 601b, 601c, 601d, 601e) are defined as quantitative requirements required of the system. In the quantitative requirement 601a, “Min cost [JPY]”, which represents cost minimization of the overall cost of the system, is defined. In the quantitative requirements 601b, “Max bandwidth [Mbps]”, which represents maximization of the communication bandwidth between the applications app1 and app2, is defined. In the quantitative requirement 601c, “Min delay [msec]”, which represents minimization of the communication delay between the applications app1 and app2, is defined. In the quantitative requirement 601d, “Max bandwidth [Kbps]”, which represents maximization of the communication bandwidth between the applications app2 and app3, is defined. In the quantitative requirement 601e, “Min delay [see]”, which represents minimization of the communication delay between the applications app2 and app3, is defined.

Note that the definition data in the requirement 600 is configured by three fields, namely “components”, “relationships”, and “requirements”, similarly to the definition data in the configuration proposal shown in FIG. 3. The components field is a field representing the definition of a component. The relationships field is a field that defines a relationship between components. The requirements field is a field that defines a quantitative requirement such as system performance or cost. However, in the second example embodiment, the variable “weight”, which is a coefficient representing the weight of the quantitative requirement in the requirements field, does not need to be defined.

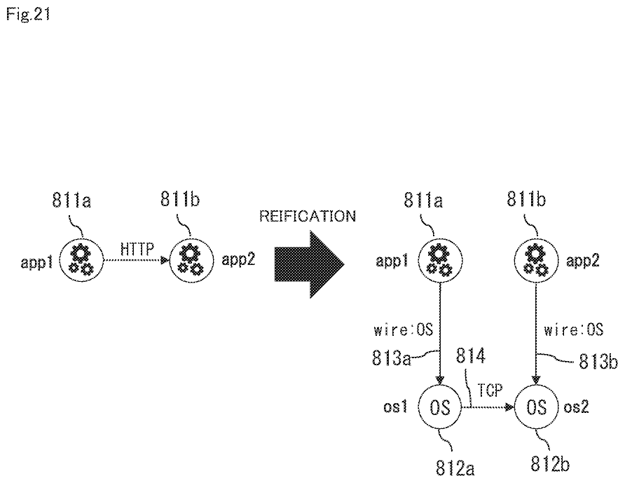

FIG. 21 is a diagram illustrating an example of configuration reification processing according to the second example embodiment. The design unit 190 partially replaces abstract elements included in the requirements and the configuration proposal with concrete configurations based on the reification rule information 191 (configuration reification processing). In FIG. 21, the system configuration before and after replacement by the configuration reification processing is shown by a set of partial graph structures. Some abstract elements may remain in the system configuration after replacement.

The design unit 190 refers to the reification rule information 191, partially reifies abstract HTTP communication between the app1 811a component and the app2 811b component that represent applications, and replaces such communication with TCP communication between the operating systems on which the applications run. Here, the graph structure on the left side of the arrow shows abstract elements that are to be replaced, and the graph structure on the right side of the arrow shows the structure in which the abstract elements have been replaced by reification. Here, “HTTP” is an abbreviation for “Hyper Text Transfer Protocol”. Also, “TCP” is an abbreviation for “Transmission Control Protocol”.

In order to realize HTTP communication between applications, the reified system configuration is the following configuration. Specifically, an os1 812a component and an os2 812b component, which each represent an OS on which an application runs, have been added, and these components are connected to the corresponding applications by wire:OS 813a and 813b, which are concrete relationships representing a host relationship with the corresponding applications. Furthermore, the two OSes (812a, 812b) are connected to each other by an abstract relationship TCP 814 representing TCP communication.

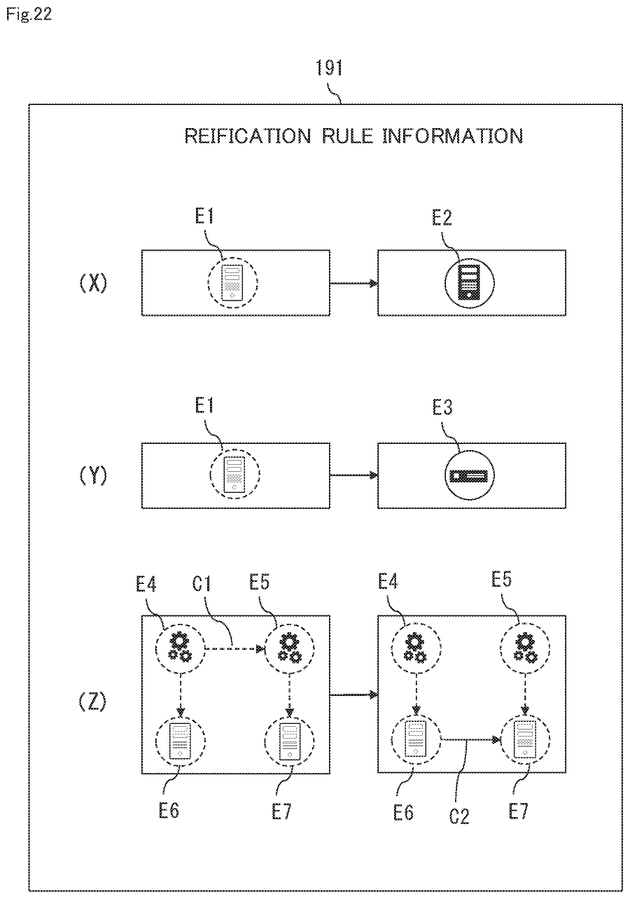

FIG. 22 is a diagram illustrating an example of the reification rule information 191 according to the second example embodiment. In the example in FIG. 22, the reification rule information 191 includes information regarding three reification rules (X), (Y), and (Z).

The reification rule (X) is a rule for converting an abstractly defined component E1 into a concretely defined component E2. The reification rule (Y) is a rule for converting an abstractly defined component E1 into a concretely defined component E3. The reification rule (Z) is a rule for converting an abstract connection method C1, which indicates connection from a component E4 hosted on a component E6 to a component E5 hosted on a component E7, into a concrete connection method C2, which indicates connection from the component E6 to the component E7. The components E4, E5, E6, and E7 are each an abstractly defined component.

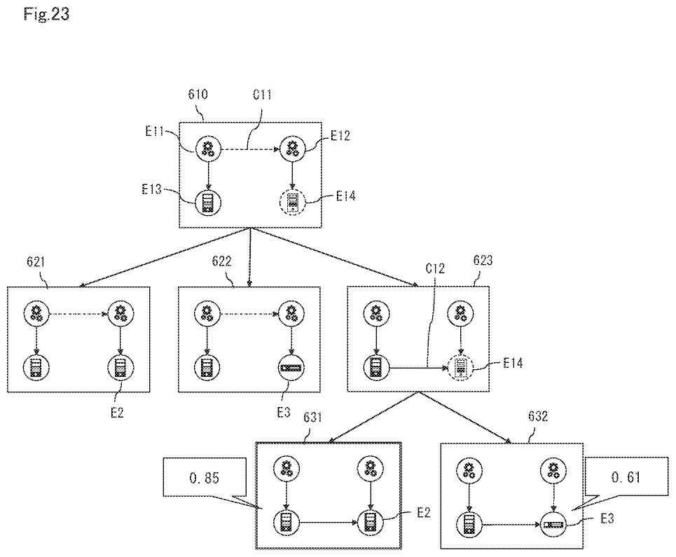

FIG. 23 is a diagram illustrating an example of design processing performed by the system configuration design apparatus 102 according to the second example embodiment. An overview of the system configuration design process performed in the design unit 190 will be described below with reference to FIGS. 22 and 23.

In the example in FIG. 23, in a requirement 610 input to the design unit 190, it is defined that a component E11 hosted on a component E13 is connected to the component E5 hosted on the component E7. At this time, it is assumed that a component E14 is an abstractly defined component, a connection method C11 is an abstractly defined connection method, and the other components and connection methods are concretely defined.

At this time, using the reification rule information 191 shown in FIG. 22, the design unit 190 can apply the reification rules (X) and (Y) to the component E14 in the requirement 610. Also, using the reification rule information 191 shown in FIG. 22, the design unit 190 can apply the reification rule (Z) to the connection method C11 in the requirement 610.

When the reification rule (X) is applied to the component E14 in the requirement 610, a configuration proposal 621 is generated in which the abstractly defined component E14 is replaced with the concretely defined component E2. When the reification rule (Y) is applied to the component E14 in the requirement 610, a configuration proposal 622 is generated in which the abstractly defined component E14 is replaced with the concretely defined component E3. When the reification rule (Z) is applied to the connection method C11 in the requirement 610, a configuration proposal 623 is generated in which the abstract connection method C11 indicating connection from the component E11 to the component E12 is replaced with the concrete connection method C12 indicating connection from the component E13 to the component E14.

The information processing apparatus 101 calculates evaluation values for the generated configuration proposals 621, 622, and 623. The design unit 190 evaluates the configuration proposals 621, 622, and 623 based on the evaluation values. Here, assuming that the configuration proposal 623 has the highest evaluation value, the design unit 190 selects the configuration proposal 623 with the highest evaluation value as the next reification target.

The component E14 is the only abstract component included in the configuration proposal 623. The reification rules (X) and (Y) can be applied to the component E14. When the reification rule (X) is applied to the component E14 in the configuration proposal 623, a configuration proposal 631 is generated in which the abstractly defined component E14 is replaced with the concretely defined component E2. When the reification rule (Y) is applied to the component E14 in the configuration proposal 623, a configuration proposal 632 is generated in which the abstractly defined component E14 is replaced with the concretely defined component E2.

Assume that when the configuration proposals 631 and 632 are input to the information processing apparatus 101, the information processing apparatus 101 calculates an evaluation value of 0.85 for the configuration proposal 631 and an evaluation value of 0.61 for the configuration proposal 632. As a result, the design unit 190 outputs the configuration proposal 631 having the higher evaluation value as the system configuration, thus completing the design.

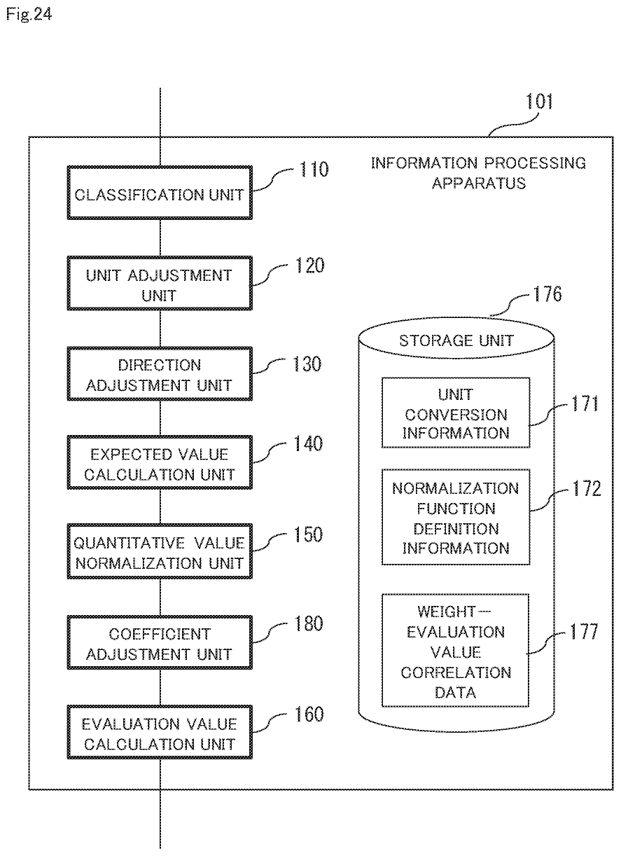

FIG. 24 is a block diagram showing an example of the configuration of the information processing apparatus 101 according to the second example embodiment. The configuration of the information processing apparatus 101 is different from the first example embodiment with respect to the coefficient adjustment unit 180 and the storage unit 176, and the other components are similar to those in the first example embodiment. Components in the second example embodiment that are similar to those according to the first example embodiment are designated by the same reference signs as in FIG. 2, and detailed description thereof will be omitted.

The coefficient adjustment unit 180 receives, as input, a list of quantitative requirements whose quantitative values have been normalized, which is output by the quantitative value normalization unit 150. The coefficient adjustment unit 180 adjusts the weighting coefficients (hereinafter simply referred to as “weights”) of the quantitative requirements whose quantitative values has been normalized.

Specifically, if the weights of the quantitative requirements have not been normalized or weights are not defined for quantitative requirements, the coefficient adjustment unit 180 refers to weight-evaluation value correlation data 177 stored in the storage unit 176 and performs weight normalization or weight calculation for the quantitative requirements. An AI trained with the weight-evaluation value correlation data 177 (hereinafter referred to as coefficient adjustment AI) may be used to perform weight normalization or weight calculation for the quantitative requirements. The coefficient adjustment unit 180 outputs the normalized or calculated weights of the quantitative requirements to the evaluation value calculation unit 160.

The storage unit 176 stores the unit conversion information 171 and the normalization function definition information 172 of the first example embodiment, as well as the weight-evaluation value correlation data 177. Here, the evaluation value of the configuration proposal calculated by the evaluation value calculation unit 160, the configuration proposal, and the quantitative requirements that are included in the configuration proposal and have undergone optimization direction adjustment are added to the weight-evaluation value correlation data 177 each time evaluation value calculation processing is performed by the evaluation value calculation unit 160.

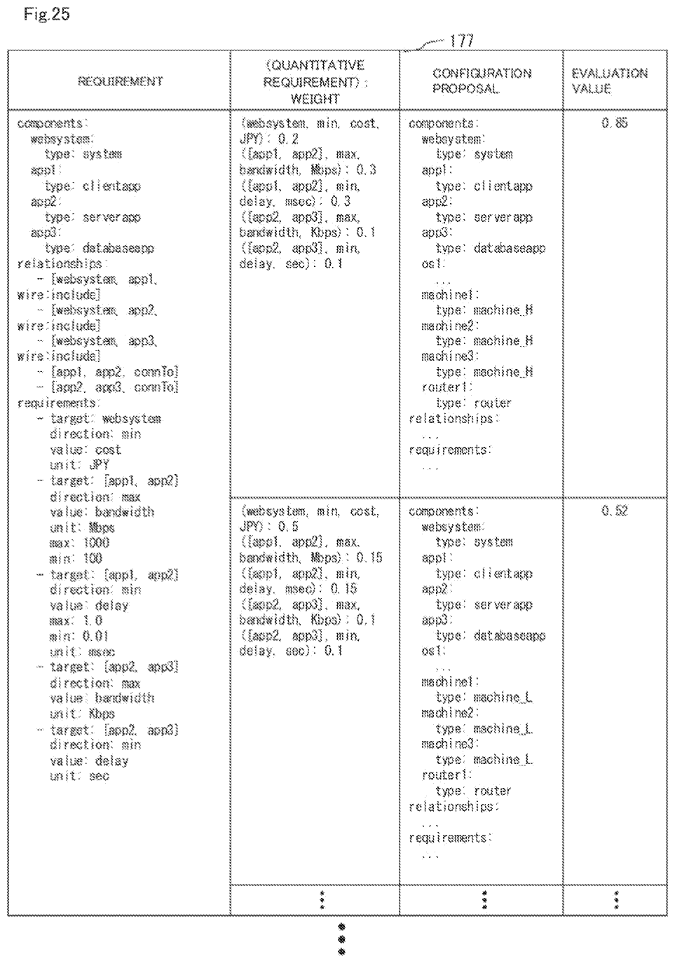

FIG. 25 is a diagram illustrating an example of the weight-evaluation value correlation data 177 according to the second example embodiment. In the weight-evaluation value correlation data 177, for each input requirement in the second example embodiment, configuration proposals that are each a design result for a corresponding combination of weights of quantitative requirements are recorded, and evaluation values of the configurations are also recorded. The evaluation values of the configurations are evaluation values calculated by the information processing apparatus 101.

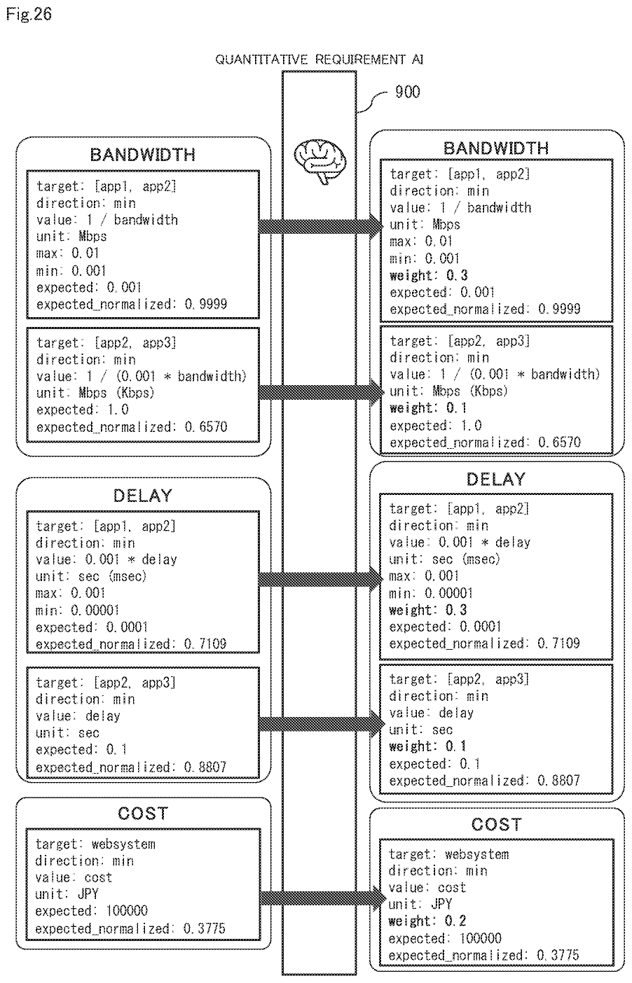

FIG. 26 is a diagram illustrating an example of processing for normalizing the weights of the quantitative requirements performed by the coefficient adjustment unit 180 according to the second example embodiment. Here, in the example in FIG. 26, it is assumed that the requirement including quantitative requirements for which weights are not defined, which is shown in FIG. 20, has been input to the system configuration design apparatus 102, and the configuration proposal generated by the design unit 190 has been input to the information processing apparatus 101.

The coefficient adjustment unit 180 (coefficient adjustment AI 900) receives, as input, the list of quantitative requirements that have undergone quantitative value normalization, which is output by the quantitative value normalization unit 150. The coefficient adjustment AI 900 is trained with the weight-evaluation value correlation data 177 read from the storage unit 176. Giving consideration to how the weights of the quantitative requirements influence the evaluation value of the configuration proposal, the coefficient adjustment AI 900 calculates weights that maximize the evaluation value, and stores the calculated weights in the “weight” field.

Note that each time the evaluation value calculation flow is executed, a pattern including the calculated evaluation value of the configuration proposal, the configuration proposal, and the quantitative requirements that are included in the configuration proposal and have undergone optimization direction adjustment is added to the weight-evaluation value correlation data 177. Hereinafter, the pattern including the calculated evaluation value of the configuration proposal, the configuration proposal, and the quantitative requirements that are included in the configuration proposal and have undergone optimization direction adjustment will be referred to as a “requirement pattern” or “requirement pattern information”.

However, before the information processing apparatus 101 receives input of requirements, a sufficient number of requirement patterns are not accumulated in the weight-evaluation value correlation data 177, and thus requirement pattern information corresponding to a sufficient number of configuration proposal patterns may be created in advance and stored. For example, for each of a plurality of requirements with different combinations of quantitative requirement weights, a plurality of patterns of concrete system configurations are designed, and the concrete system configurations are constructed. Then, the weight-evaluation value correlation data 177 may be created by evaluating the degree to which the quantitative requirements of the concrete system configurations are satisfied, and manually inputting the evaluation values obtained from the evaluation.

### [System Operation]

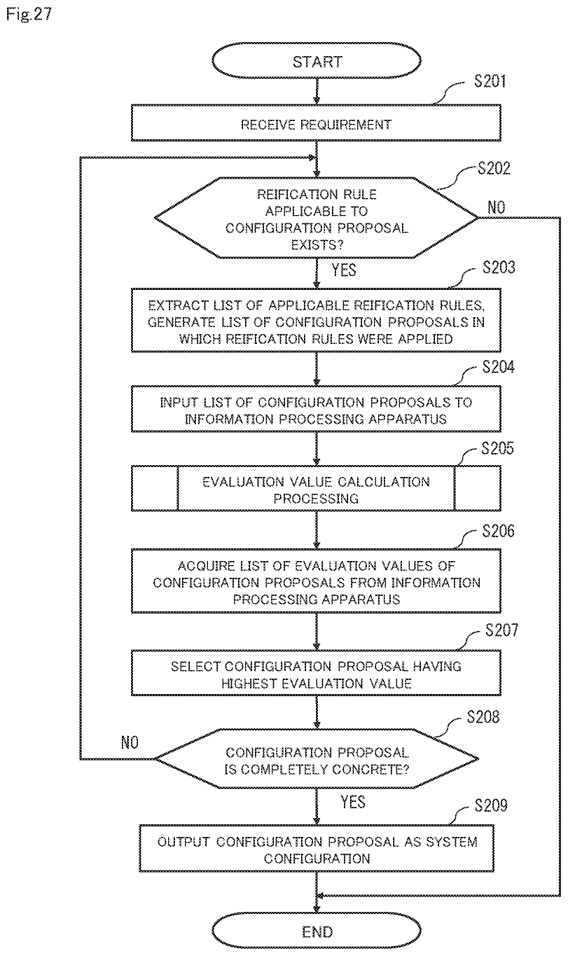

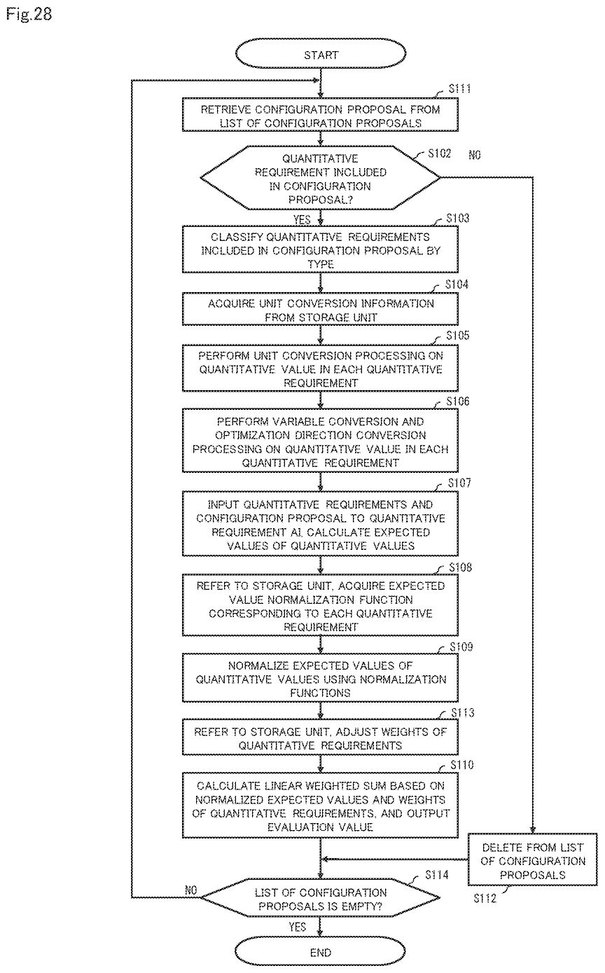

Next, overall operation of the second example embodiment will be described in detail with reference to the flowcharts of FIGS. 27 and 28.

FIG. 27 is a flowchart showing operation of the system configuration design apparatus according to the second example embodiment. First, the requirement 600 is input to the design unit 190 of the system configuration design apparatus 102 (step S201).

Next, the design unit 190 refers to the reification rule information 191 and determines whether or not the reification rule information 191 includes a reification rule that can be applied to the requirement 600 (step S202). If the reification rule information 191 does not include a reification rule that can be applied to the requirement 600 (step S202: NO), the design unit 190 determines that the design of the system configuration is inapplicable or that the system configuration does not include abstract elements or configurations, and ends operation.

If the reification rule information 191 includes a reification rule that can be applied to the requirement 600 (step S202: YES), the design unit 190 generates a list of configuration proposals in which the applicable reification rule has been applied to the requirement 600 (step S203). Next, the design unit 190 inputs the generated list of configuration proposals to the information processing apparatus 101 (step S204). Next, the information processing apparatus 101 executes evaluation value calculation processing (step S205). The evaluation value calculation processing (step S205) will be described below in detail with reference to FIG. 28.

After completing the evaluation value calculation processing, the information processing apparatus 101 outputs a list of the evaluation values of the configuration proposals to the design unit 190 (step S206). The design unit 190 selects the configuration proposal having the highest evaluation value from the list of evaluation values as the next configuration proposal to be reified (step S207).

Next, the design unit 190 determines whether the configuration proposal is completely concrete. If the design unit 190 determines that the configuration proposal is not completely concrete and includes abstract elements (step S208: NO), the processing returns to step S202. If it is determined that the configuration proposal is completely concrete (step S208: YES), the design unit 190 outputs the configuration proposal as the system configuration information 700 that is the design result (step S209), and ends operation.

FIG. 28 is a flowchart showing details of the evaluation value calculation processing (step S205 in FIG. 27) performed by the information processing apparatus according to the second example embodiment. In FIG. 28, operations similar to those in the first example embodiment are designated by the same reference signs as in FIG. 17, and detailed description thereof will be omitted.

The quantitative requirement classification unit 110 first retrieves one configuration proposal from the input list of configuration proposals (step S111), and determines whether a quantitative requirement is included in the configuration proposal. If a quantitative requirement is not included (step S102: NO), the quantitative requirement classification unit 110 determines that an evaluation value cannot be calculated for the configuration proposal, deletes the configuration proposal from the list (step S112), and moves to the processing of step S114. If a quantitative requirement is included (step S102: YES), the operations from step S103 to step S109 are performed similarly to the first example embodiment.

Next, the coefficient adjustment unit 180 receives, as input, a list of quantitative requirements output from the quantitative value normalization unit 150. If the weights of the quantitative requirements have not been normalized or weights are not defined for the quantitative requirements, the coefficient adjustment unit 180 adjusts the weights of the quantitative requirements based on the weight-evaluation value correlation data 177 read from the storage unit 176 (step S113). In other words, the coefficient adjustment unit 180 performs weight normalization or weight calculation for the quantitative requirements based on the weight-evaluation value correlation data 177. The coefficient adjustment unit 180 outputs the normalized or calculated weights of the quantitative requirements to the evaluation value calculation unit 160.

The evaluation value calculation unit 160 calculates a linear weighted sum based on the input normalized expected values of the quantitative requirements and the normalized or calculated weights of the quantitative requirements. The evaluation value calculation unit 160 outputs the linear weighted sum as the evaluation value of the configuration proposal (step S110).

After the processing in step S110 or step S112, the evaluation value calculation unit 160 determines whether the list of configuration proposals is empty. If the list of configuration proposals is not empty (step S114: NO), the processing returns to step S111. If the list of configuration proposals is empty (step S114: YES), the evaluation value calculation unit 160 determines that evaluation value calculation has been completed for all configuration proposals, and ends the evaluation value calculation flow.

### Effects of Second Example Embodiment

In this way, according to the second example embodiment, in addition to the effects of the first example embodiment, it is possible to automate system design that takes quantitative requirements into consideration and is performed using learning-based system automatic design technology. This makes it possible to further reduce the burden on engineers involved in system design that has conventionally required manual adjustment.

### [Program]

The program according to the second example embodiment may be a program that causes a computer to execute the processes described in FIGS. 27 and 28. By installing this program in a computer and executing the program, the system configuration design apparatus 102, the information processing apparatus 101 and the information processing method according to the second example embodiment can be realized. Further, the processor of the computer performs processing to function as the design unit 190, the quantitative requirement classification unit 110, the unit adjustment unit 120, the direction adjustment unit 130, the expected value calculation unit 140, the quantitative value normalization unit 150 the evaluation value calculation unit 160 and coefficient adjustment unit 180.

Also, the program according to the second example embodiment may be executed by a computer system constructed by a plurality of computers. In this case, for example, each computer may function as any of the design unit 190, the quantitative requirement classification unit 110, the unit adjustment unit 120, the direction adjustment unit 130, the expected value calculation unit 140, the quantitative value normalization unit 150 the evaluation value calculation unit 160 and coefficient adjustment unit 180.

In the second example embodiment, the storage units 176 and 192 may be realized by storing the data files that comprise them in a hard disk or other storage device provided in a computer, or it may be realized by a storage device in another computer.

### [Physical Configuration]

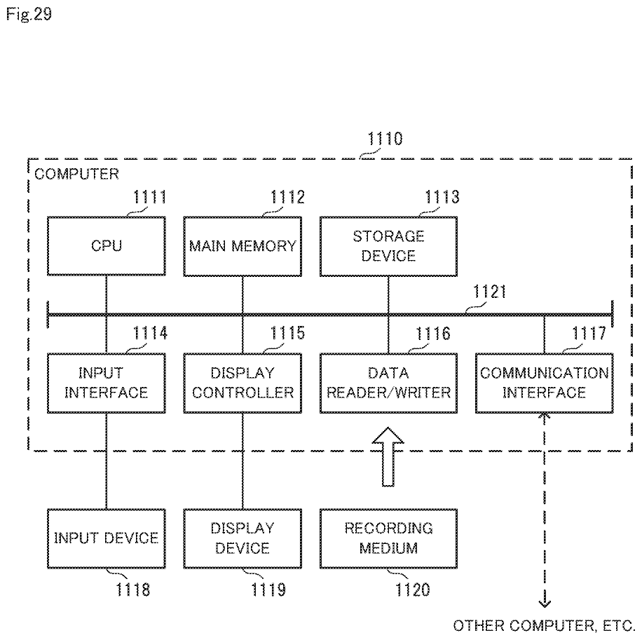

A computer that realizes an information processing apparatus 100 by executing the program according to the first example embodiment and the system configuration design apparatus 102 and the information processing apparatus 101 by executing the program in the second example embodiment will be described with reference to FIG. 29. FIG. 29 is a block diagram showing an example of a computer that realizes the information processing apparatus according to the first and second example embodiments.

As shown in FIG. 29, a computer 1110 includes a CPU 1111, a main memory 1112, a storage device 1113, an input interface 1114, a display controller 1115, a data reader/writer 1116, and a communication interface 1117. These units are connected via bus 1121 so as to be able to perform data communication with each other. Note that the computer 1110 may include a GPU or a FPGA in addition to the CPU 1111 or instead of the CPU 1111.

The CPU 1111 loads a program (codes) according to the first and second example embodiments and the first and second working examples stored in the storage device 1113 to the main memory 1112, and executes them in a predetermined order to perform various kinds of calculations. The main memory 1112 is typically a volatile storage device such as a DRAM (Dynamic Random Access Memory). Also, the program according to the first and second example embodiments and the first and second working examples are provided in the state of being stored in a computer-readable recording medium 1120. Note that the program according to the first and second example embodiments and the first and second working examples may be distributed on the Internet that is connected via the communication interface 1117.

Specific examples of the storage device 1113 include a hard disk drive, and a semiconductor storage device such as a flash memory. The input interface 1114 mediates data transmission between the CPU 1111 and the input device 1118 such as a keyboard or a mouse. The display controller 1115 is connected to a display device 1119, and controls the display of the display device 1119.

The data reader/writer 1116 mediates data transmission between the CPU 1111 and the recording medium 1120, and reads out the program from the recording medium 1120 and writes the results of processing performed in the computer 1110 to the recording medium 1120. The communication interface 1117 mediates data transmission between the CPU 1111 and another computer.

Specific examples of the recording medium 1120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

The information processing apparatus 100 according to the first example embodiment can also be realized by using hardware corresponding to each unit, for example, an electronic circuit, instead of a computer in which a program is installed. Similarly, the information processing apparatus 101 and the system configuration design apparatus 102 in the second example embodiment can also be realized by using hardware corresponding to each unit, for example, an electronic circuit, instead of a computer in which a program is installed. Furthermore, a part of each of the information processing apparatus 100, the information processing apparatus 101 and the system configuration design apparatus 102 may be realized by a program, and the remaining part may be realized by hardware. In the embodiment, the computer is not limited to the computer 1110 shown in FIG. 29.

Although the invention of this application has been described with reference to the first and second example embodiments, the invention of this application is not limited to the above example embodiments. Within the scope of the invention of this application, various changes that can be understood by those skilled in the art can be made to the configuration and details of the invention of this application.

According to the technology described above, it can be applied to applications such as the design and construction of ICT systems and communication networks.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing apparatus comprising:
at least one memory storing instructions; and
at least one processor configured to execute the instructions to:
acquire configuration proposal information including a plurality of first quantitative requirements that are each a combination of quantitative requirements each representing a requirement in which a quantitative value regarding a configuration of a first information communication system is set;
calculate an expected value of each of the quantitative values in each of the first quantitative requirements based on a second quantitative requirement that is a combination of quantitative requirements each representing a requirement in which a quantitative value regarding configurations of a plurality of second information communication systems is set;
for each of the first quantitative requirements, convert a value range of the expected value of each of the quantitative values of the first quantitative requirement to a certain range based on a normalization function defined according to a type of the first quantitative requirement;
calculate an evaluation value of the configuration proposal information based on the converted expected values of the quantitative values of the first quantitative requirements; and
output the evaluation value to an output device.

2. The information processing apparatus according to claim 1, wherein the at least one processor is further configured to execute the instructions to:
classify the first quantitative requirements based on the types of the first quantitative requirements.

3. The information processing apparatus according to claim 1, wherein the at least one processor is further configured to execute the instructions to:
for each of the first quantitative requirements, perform unit conversion on each of the quantitative values included in the first quantitative requirement based on the type of the first quantitative requirement.

4. The information processing apparatus according to claim 1, wherein the at least one processor is further configured to execute the instructions to:
for each of the first quantitative requirements, determine a direction of optimization of each of the quantitative values included in the first quantitative requirement based on predetermined information included in the first quantitative requirement.

5. The information processing apparatus according to claim 1, wherein the at least one processor is further configured to execute the instructions to:
store first conversion information including a unit conversion rule for conversion between units of the quantitative values in the first quantitative requirements, and stores normalization function definition information regarding normalization functions defined according to the types of the first quantitative requirements.

6. The information processing apparatus according to claim 1, wherein the at least one processor is further configured to execute the instructions to:
for each of the first quantitative requirements, convert the value range of each of the quantitative values in the first quantitative requirement to a certain range based on an upper limit value or a lower limit value of the quantitative value defined in the first quantitative requirement, or based on a normalization function determined using a definition of the upper limit value and the lower limit value of the quantitative value.

7. The information processing apparatus according to claim 1, wherein the at least one processor is further configured to execute the instructions to:
acquire requirement information including a plurality of first requirements that are each a combination of requirements regarding a configuration of the first information communication system; and
based on rule information defining a rule according to which a first element or a first relationship between elements defined in a first format regarding a configuration of the first information communication system is replaced with one or more second elements or a second relationship between elements defined in a second format, for each of the first requirements, replace a requirement corresponding to the first element or the first relationship with a quantitative requirement corresponding to a second element or the second relationship.

8. The information processing apparatus according to claim 7, wherein the at least one processor is further configured to execute the instructions to:
normalize or calculate weighting coefficients for the quantitative requirements using a second artificial intelligence trained based on correlation information between pieces of configuration proposal information, which each correspond to a combination of weighting coefficients for the quantitative requirements, and evaluation values of the pieces of configuration proposal information.

9. An information processing method for causing a computer to perform:
acquiring configuration proposal information including a plurality of first quantitative requirements that are each a combination of quantitative requirements each representing a requirement in which a quantitative value regarding a configuration of a first information communication system is set;
calculating an expected value of each of the quantitative values in each of the first quantitative requirements based on a second quantitative requirement that is a combination of quantitative requirements each representing a requirement in which a quantitative value regarding configurations of a plurality of second information communication systems is set;
converting, for each of the first quantitative requirements, a value range of the expected value of each of the quantitative values of the first quantitative requirement to a certain range based on a normalization function defined according to a type of the first quantitative requirement;
calculating an evaluation value of the configuration proposal information based on the converted expected values of the quantitative values of the first quantitative requirements; and
outputting the evaluation value to an output device.

10. A non-transitory computer-readable recording medium having recorded thereon a program including instructions for causing a computer to execute the processing of:
acquiring configuration proposal information including a plurality of first quantitative requirements that are each a combination of quantitative requirements each representing a requirement in which a quantitative value regarding a configuration of a first information communication system is set;
calculating an expected value of each of the quantitative values in each of the first quantitative requirements based on a second quantitative requirement that is a combination of quantitative requirements each representing a requirement in which a quantitative value regarding configurations of a plurality of second information communication systems is set;
converting, for each of the first quantitative requirements, a value range of the expected value of each of the quantitative values of the first quantitative requirement to a certain range based on a normalization function defined according to a type of the first quantitative requirement;
calculating an evaluation value of the configuration proposal information based on the converted expected values of the quantitative values of the first quantitative requirements; and
outputting the evaluation value to an output device.
